(19) United States
(12) Patent Application Publication
(10) Pub. No.: US 2004/0234121 A1
(43) Pub. Date: Nov. 25, 2004

(54) Circuit wiring inspetion instrument and circuit wiring inspecting method

(76) Inventors: Tatsuhisa Fujii, Hiroshima (JP); Kazuhiro Monden, Hiroshima (JP); Mikiya Kasai, Hiroshima (JP); Shogo Ishioka, Hiroshima (JP); Shuji Yamaoka, Hiroshima (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/487,831

(22) PCT Filed: Aug. 27, 2002
(86) PCT No.: PCT/JP02/08598

(30) Foreign Application Priority Data
Aug. 27, 2001 (JP) 2001-255620

(51) Int. Cl. G06K 9/00

(52) U.S. Cl. 382/147

(57) ABSTRACT

Disclosed is a method for inspection a circuit wiring on a circuit board, which comprises the steps of supplying an inspection signal to the circuit wiring (S141), detecting potential variation which is generated in the circuit wiring in response to the supplied inspection signal, by use of a plurality of sensor elements (S142), and creating image data representing the shape of the circuit if the detected potential variation at the specific position is out of a given range (S143-N), while omitting the generation of the image data if the detected potential variation at the specific position falls within the given range (S143-Y).

### TECHNICAL FIELD

The present invention relates to a circuit-wiring inspecting apparatus and method for inspecting a circuit wiring.

### BACKGROUND ART

In manufacturing processes of a circuit board, it is required to inspect the presence of disconnection and/or short-circuit in circuit wirings formed on a circuit board. The recent progressive densification of circuit wirings causes difficulties in assuring a sufficient space for simultaneously arranging a plurality of inspection pins at both ends of individual circuit wirings and bringing the tips of the inspection pins into contact with the corresponding ends of the circuit wirings during the operation of inspecting circuit wirings. In view of such circumstances, there has been proposed a non-contact type inspection technique allowing electric signals from circuit wirings to be received without any contact with both ends of the circuit wirings (see Japanese Patent Laid-Open Publication No. Hei 9-264919).

As is shown in FIG. 22, this non-contact type inspection technique comprises bringing an inspection pin into contact with one of the ends of a specific circuit wiring to be inspected (hereinafter referred to as “target circuit wiring”), placing a sensor conductor at the other end of the target circuit wiring in non-contact manner, supplying an inspection signal from the inspection pin to change the potential of the target circuit wiring, and detecting the potential variation using the sensor conductor to inspect the presence of disconnection or the like in the target circuit wiring.

The above conventional non-contact type inspection technique is intended to simply detect whether a circuit wiring exists at a certain position (a portion of the circuit wiring located at the certain position has a potential variation). Thus, it has been able to readily evaluate the state of the entire circuit wiring between both ends thereof, or an operator could not intuitively evaluate the state of the entire circuit wiring.

In view of the above problems, it is an object of the present invention to provide a circuit-wiring inspecting apparatus capable of solving the above problems, for example, allowing an operator to evaluate the state of a circuit wiring in a simple control readily and intuitively.

### DISCLOSURE OF THE INVENTION

In order to achieve the above object, according to a first aspect of the present invention, there is provided an inspection apparatus for inspecting a circuit wiring on a circuit board. This inspection apparatus comprises: supply means for supplying an inspection signal to the circuit wiring; detecting means for detecting potential variation which is generated in the circuit wiring in response to the inspection signal, by use of a plurality of sensor elements; image-data creating means for creating image data representing the shape of the circuit wiring in accordance with positional information from one or more of the plurality of sensor elements which have sensed the potential variation; and inspection control means for controlling the detecting means to detect the potential variation at a specific position of the circuit wiring. The inspection control means is operable to control the image-data creating means to create the image data if the detected potential variation at the specific position is out of a given range.

In the inspection apparatus set forth in the first aspect of the present invention, if the circuit wiring is formed on the circuit board in a plural number, the supply means may be operable to supply the inspection signal to each of the circuit wirings at a different timing.

The inspection apparatus set forth in the first aspect of the present invention may further include selecting means for generating a selection signal to selectively drive only a part of the plurality of sensor elements. Further, the plurality of sensor elements may be formed in a matrix arrangement. In this case, the selecting means may be operable to input the selection signal simultaneously to one of a plurality of horizontal sensor-element lines of the sensor elements formed in the matrix arrangement, and the detecting means may be operable to simultaneously detect the potential variation from the sensor elements of the one sensor-element line located in opposed relation to at least a portion of the circuit wiring.

The circuit wiring may include a first circuit wiring and a second circuit wiring. In this case, the selecting means may be operable to input the selection signal in turn to the plurality of sensor-element lines so as to drive all of the sensor elements, and the inspection control means may be operable to control the detecting means to detect the potential variation from all of the sensor elements in synchronous with the input timing of the selection signal from the selecting means. Further, the supply means may be operable to supply the inspection signal to the first and second circuit wirings within the same frame (wherein one frame is a time period required for driving each of the plurality of sensor elements once) if no common sensor-element line is included between a first group of the sensor-element lines capable of detecting the potential variation in the first circuit wiring, and a second group of the sensor-element lines capable of detecting the potential variation in the second circuit wiring, and to supply the inspection signal to the first and second circuit wirings, respectively, in different frames, if one or more common sensor-element lines are included between the first and second groups of the sensor-element lines.

In the inspection apparatus set forth in the first aspect of the present invention, the specific position of the circuit wiring may be set around the input/output end of the circuit wiring.

According to a second aspect of the present invention, there is provided an inspection method for inspecting a circuit wiring on a circuit board. This inspection method comprises the steps of: supplying an inspection signal to the circuit wiring; detecting potential variation which is generated in the circuit wiring in response to the supplied inspection signal, by use of a plurality of sensor elements; and creating image data representing the shape of the circuit wiring in accordance with positional information from one or more of the plurality of sensor elements which have sensed the potential variation. The detecting step includes detecting the potential variation at a specific position of the circuit wiring while supplying the inspection signal to the circuit wiring, and the creating step includes creating the image data if the detected potential variation at the specific position is out of a given range, while omitting the generation of the image data if the detected potential variation at the specific position falls within the given range.

In the inspection method set forth in the second aspect of the present invention, if the circuit wiring is formed on the circuit board in a plural number, the supplying step may include supplying the inspection signal to each of the circuit wirings at a different timing.

The inspection method set forth in the second aspect of the present invention may further include Step of selectively driving only a part of the plurality of sensor elements corresponding to the circuit wiring. If the plurality of sensor elements are formed in a matrix arrangement, the driving step may include supplying the selection signal simultaneously to one of a plurality of horizontal sensor-element lines of the sensor elements formed in the matrix arrangement, and the detecting step may include simultaneously detecting the potential variation from the sensor elements of the one sensor-element line located in opposed relation to at least a portion of the circuit wiring.

If the circuit wiring includes a first circuit wiring and a second circuit wiring, the driving step may include inputting the selection signal in turn to the plurality of sensor-element lines so as to drive all of the sensor elements, and the detecting step may include detecting the potential variation from all of the sensor elements in synchronous with the input timing of the selection signal. Further, the supplying step may include supplying the inspection signal to the first and second circuit wirings within the same frame (wherein one frame is a time period required for driving each of the sensor elements once) if no common sensor-element line is included between a first group of the sensor-element lines capable of detecting the potential variation in the first circuit wiring, and a second group of the sensor-element lines capable of detecting the potential variation in the second circuit wiring, and supplying the inspection signal to the first and second circuit wirings, respectively, in different frames if one or more common sensor-element lines are included between the first and second groups of the sensor-element lines.

In the inspection method set forth in the second aspect of the present invention, the specific position of the circuit wiring is set around the input/output end of the circuit wiring.

According to a third aspect of the present invention, there is provided an inspection apparatus for inspecting a circuit wiring on a circuit board. This inspection apparatus comprises: supply means for supplying an inspection signal to the circuit wiring; detecting means for detecting potential variation which is generated in the circuit wiring in response to the inspection signal, by use of a plurality of sensor elements; and inspection control means for controlling the detecting means to detect the potential variation at a specific position of the circuit wiring.

According to a fourth aspect of the present invention, there is provided an inspection apparatus for inspecting a circuit wiring on a circuit board. This inspection apparatus comprises: supply means for supplying an inspection signal to the circuit wiring; detecting means for detecting potential variation which is generated in the circuit wiring in response to the inspection signal, by use of a plurality of sensor elements; image-data creating means for creating image data representing the shape of the circuit wiring in accordance with positional information from one or more of the plurality of sensor elements which have sensed the potential variation; and inspection control means for controlling the detecting means to detect the potential variation at a specific position of the circuit wiring.

In the inspection apparatus set forth in the third or fourth aspect of the present invention, the circuit wiring may be formed on the circuit board in a plural number. In this case, the supply means may be operable to supply the inspection signal to each of the circuit wirings at a different timing.

The inspection apparatus set forth in the third or fourth aspect of the present invention may further include selecting means for generating a selection signal to selectively drive only a part of the plurality of sensor elements. Further, the plurality of sensor elements may be formed in a matrix arrangement. In this case, the selecting means may be operable to input the selection signal simultaneously to one of a plurality of horizontal sensor-element lines of the sensor elements formed in the matrix arrangement, and the detecting means may be operable to simultaneously detect the potential variation from the sensor elements of the one sensor-element line located in opposed relation to at least a portion of the circuit wiring.

Furthermore, the circuit wiring may include a first circuit wiring and a second circuit wiring. In this case, the selecting means may be operable to input the selection signal in turn to the plurality of sensor-element lines so as to drive all of the sensor elements, and the inspection control means may be operable to control the detecting means to detect the potential variation from all of the sensor elements in synchronous with the input timing of the selection signal from the selecting means. Further, the supply means may be operable to supply the inspection signal to the first and second circuit wirings within the same frame (wherein one frame is a time period required for driving each of the plurality of sensor elements once) if no common sensor-element line is included between a first group of the sensor-element lines capable of detecting the potential variation in the first circuit wiring, and a second group of the sensor-element lines capable of detecting the potential variation in the second circuit wiring, and to supply the inspection signal to the first and second circuit wirings, respectively, in different frames, if one or more common sensor-element lines are included between the first and second groups of the sensor-element lines.

The plurality of sensor elements may be formed in a matrix arrangement including a plurality of sensor-element lines. In this case, the selecting means may be operable to selectively drive only one or more of the sensor-element lines corresponding to the circuit wiring to be inspected, and the detecting means may be operable to simultaneously detect the potential variation from the sensor elements of the one or more sensor-element lines located in opposed relation to at least a portion of the circuit wiring.

In the inspection apparatus set forth in the third or fourth aspect of the present invention, the specific position of the circuit wiring may be set around the input/output end of the circuit wiring.

According to a fifth aspect of the present invention, there is provided an inspection method for inspecting a circuit wiring on a circuit board. This method comprises Steps of: supplying an inspection signal to the circuit wiring; and detecting potential variations which is generated in the circuit wiring in response to the supplied inspection signal, by use of a plurality of sensor elements. The detecting step includes detecting the voltage variation at a specific position of the circuit wiring while supplying the inspection signal to the circuit wiring.

According to a sixth aspect of the present invention, there is provided an inspection method for inspecting a circuit wiring on a circuit board. This method comprises Steps of: supplying an inspection signal to the circuit wiring; detecting potential variation which is generated in the circuit wiring in response to the supplied inspection signal, by use of a plurality of sensor elements; and creating image data representing the shape of the circuit wiring in accordance with positional information from one or more of the plurality of sensor elements which have sensed the potential variation. The detecting step includes detecting the potential variation at a specific position of the circuit wiring while supplying the inspection signal to the circuit wiring, and the creating step includes creating the image data representing the shape of the region of the circuit wiring in accordance with the potential variation detected at the specific position.

In the inspection method set forth in the fifth or sixth aspect of the present invention, if the circuit wiring is formed on the circuit board in a plural number, the supplying step may include supplying the inspection signal to each of the circuit wirings at a different timing.

The inspection method set forth in the fifth or sixth aspect of the present invention may further include Step of selectively driving only a part of the plurality of sensor elements corresponding to the circuit wiring.

Further, if the plurality of sensor elements are formed in a matrix arrangement, the driving step may include supplying the selection signal simultaneously to one of a plurality of horizontal sensor-element lines of the sensor elements formed in the matrix arrangement, and the detecting step may include simultaneously detecting the potential variation from the sensor elements of the one sensor-element line located in opposed relation to at least a portion of the circuit wiring.

If the plurality of sensor elements are formed in a matrix arrangement including a plurality of sensor-element lines, the driving step may include selectively driving only one or more of the sensor-element lines corresponding to the circuit wiring to be inspected, and the detecting step may include simultaneously detecting the potential variation from the sensor elements of the one or more sensor-element lines located in opposed relation to at least a portion of the circuit wiring.

Furthermore, if the circuit wiring includes a first circuit wiring and a second circuit wiring, the driving step may include inputting the selection signal in turn to the plurality of sensor-element lines so as to drive all of the sensor elements, and the detecting step may include detecting the potential variation from all of the sensor elements in synchronous with the input timing of the selection signal. Further, the supplying step may include supplying the inspection signal to the first and second circuit wirings within the same frame (wherein one frame is a time period required for driving each of the sensor elements once) if no common sensor-element line is included between a first group of the sensor-element lines capable of detecting the potential variation in the first circuit wiring, and a second group of the sensor-element lines capable of detecting the potential variation in the second circuit wiring, and supplying the inspection signal to the first and second circuit wirings, respectively, in different frames if one or more common sensor-element lines are included between the first and second groups of the sensor-element lines.

In the inspection method set forth in the fifth or sixth aspect of the present invention, the specific position of the circuit wiring is set around the input/output end of the circuit wiring.

### BRIEF DESCRIPTION OF THE DRAWINGS

FIG. 1 is a schematic diagram of an inspection system according to a first embodiment of the present invention.

FIG. 2 is a block diagram showing the computer hardware configuration of the inspection system.

FIG. 3 is a block diagram showing the electrical configuration of a sensor chip 1 of the inspection system.

FIG. 4 is an explanatory block diagram of a sensor element of the inspection system.

FIG. 5 is an explanatory model diagram of the principle of current generation in the sensor element caused by potential variation in a circuit wiring.

FIG. 6 is an explanatory model diagram of the principle of current generation in the sensor element due to potential variation in a circuit wiring.

FIG. 7 is a timing chart of one example of input/output timings in case where MOSFET is used as the sensor chip.

FIG. 8 is an explanatory diagram of an operation for inspecting circuit wirings (1) to (3) using 6×6 sensor elements of the inspection system.

FIG. 9 is a timing chart showing voltage supply timings to the circuit wirings in FIG. 8 and the timing of outputting data.

FIG. 10 is an explanatory diagram of a sensor drive sequence in the inspection system, in case where a single circuit board is formed with a plurality of circuit wirings.

FIG. 11 is a timing chart showing one example of voltage supply timings for the sensor drive control in FIG. 10.

FIG. 12 is a table for determining a voltage supply sequence to a plurality of circuit wirings, in the inspection system.

FIG. 13 is a table for determining a voltage supply sequence to a plurality of circuit wirings, in the inspection system.

FIG. 14 is a flow chart showing a processing for extracting target data from a gold sample in the inspection system.

FIG. 15 is an explanatory flow chart of an inspection control in the inspection system.

FIG. 16 is a diagram showing one example of the arrangement of specific points for the inspection control in the inspection system.

FIG. 17 is a flow chart showing a processing for determining displacement in accordance with CAD data in an inspection system according to a second embodiment of the present invention.

FIG. 18 is an explanatory diagram of a voltage supply sequence to a plurality of circuit wirings formed on a single circuit board, in an inspection system according to a third embodiment of the present invention.

FIG. 19 is a timing chart showing one example of a voltage supply timing to the circuit wirings in FIG. 16, in the inspection system according to a third embodiment of the present invention.

FIG. 20 is a diagram showing an output image obtained by applying voltage at the timing in FIG. 19.

FIG. 21 is an explanatory timing chart of one example of input/output timings for inspecting circuit wirings arranged in two lines according to the sensor-element control in FIG. 10.

FIG. 22 is an explanatory diagram of a sensor drive sequence to a plurality of circuit wirings formed in a single circuit board, in an inspection system according a fourth embodiment of the present invention.

FIG. 23 is an explanatory timing chart of one example of input/output timings in case where MOSFET is used as a sensor chip in the inspection system according to the fourth embodiment.

FIG. 24 is an explanatory diagram of a conventional circuit-board inspection apparatus

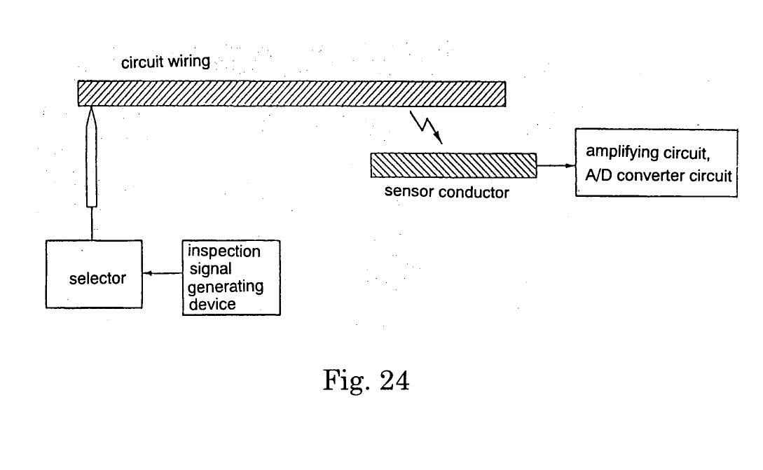

### BEST MODE FOR CARRYING OUT THE INVENTION

With reference to the drawings, an embodiment of the present invention will now be described in detail.

While the following description is made in connection with specific embodiment, the present invention is not limited to any structures, arrangements of components and numerical values of the specific embodiments.

### FIRST EMBODIMENT

A first embodiment of the present invention will be described in conjunction with an inspection system 20 using a MOSFET as a sensor element.

<Construction of Inspection System>

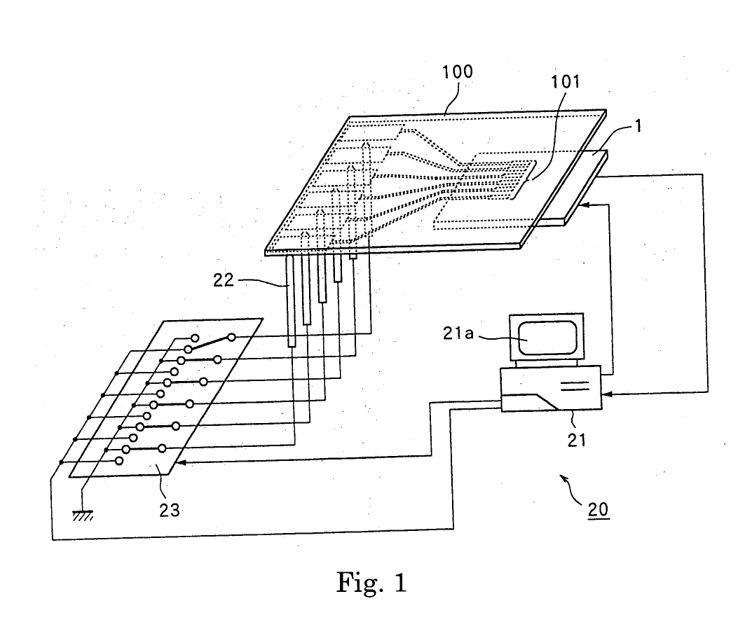

FIG. 1 is a schematic diagram of the inspection system 20 according to the first embodiment.

The inspection system 20 comprises a sensor chip 1 having a plurality of sensor elements, a computer 21, a plurality of probes 22 for supplying an inspection signal to corresponding circuit wirings 101, and a selector 23 for switchingly supply the inspection signal to each of the probes 22. For example, the selector 23 may be composed of a multiplexer or a duplexer.

The computer 21 supplies to the selector 23 a control signal for selecting at least one of the probes 22 and an inspection signal to be supplied to at least one of the circuit wirings 101 to be inspected (hereinafter referred to as “target circuit wiring”). The computer 21 also supplies to the sensor chip 1 a synchronization signal [a vertical synchronization signal (Vsync), a horizontal synchronization signal (Hsync), and a reference signal (Dclk)] for allowing the sensor elements to be operated in synchronous with the control signal supplied to the selector 23.

The inspection signal to be supplied to the circuit wirings may be either one of a voltage pulse and an AC signal. When the voltage pulse is used, the polarity of the signal can be specified, and thereby a related circuit can be designed under the condition that the current direction in the sensor elements is limited to one direction. Thus, the circuit design will be simplified.

Further, the computer 21 receives from the sensor chip 1 a detection signal generated in response to an inspection signal passing through a circuit wiring. Then, the computer 21 creates an image data corresponding to the pattern of the circuit wiring through which the inspection signal has passed, and displays a created image on a display 21a of the computer 21.

This makes it possible to find out the shape of specific one of the circuit wirings and to detect defects, such as disconnection, short circuit or chipping, in the circuit wirings 101 based on the created image data and design image data representing a corresponding design circuit wiring.

Each of the probes 22 has a tip in contact with one of the ends of the circuit wiring 101 on the circuit board 100 to supply an inspection signal to one of the circuit wirings 101.

The selector 23 switchingly selects at least one of the probes 22 to be supplied with an inspection signal. Specifically, the selector 23 performs a switching operation according to a control signal supplied from the computer 21 to allow an inspection signal to be supplied to each of the independent circuit wirings 101 on the circuit board 100 individually.

The selector 23 also performs the switching operation in such a manner that the circuit wirings not to be supplied with an inspection signal (hereinafter referred to as “non-target circuit wiring) are connected to a ground level (GND) or a low impedance line such as a power source. This is done to prevent the sensor elements from receiving an error signal otherwise caused by transferring an inspection signal from a target circuit wiring to non-target circuit wirings due to cross talk.

The sensor chip 1 is disposed at a position opposed to the circuit wirings 101 on the circuit board 100 in a non-contact manner to detect potential variation which is generated in the circuit wiring 101 in response to an inspection signal supplied from the probe 22, and then output the detected potential variation to the computer 21 as a detection signal. The distance between the sensor chip 1 and the circuit wirings may be set at 0.5 mm or less, preferably 0.05 mm or less. The sensor chip 1 may be arranged at a position close to the circuit board while interposing a dielectric insulating material therebetween.

While the circuit wirings 101 of the circuit board 100 of FIG. 1 are formed on only one of the side surfaces of the circuit board 100, the inspection system according to this embodiment can also inspect a circuit board having the circuit wiring 101 formed on both side surfaces thereof. In this case, the inspection operation may be performed by preparing two of the sensor chips 1 and locating them on the upper and lower sides of to sandwich the circuit board therebetween.

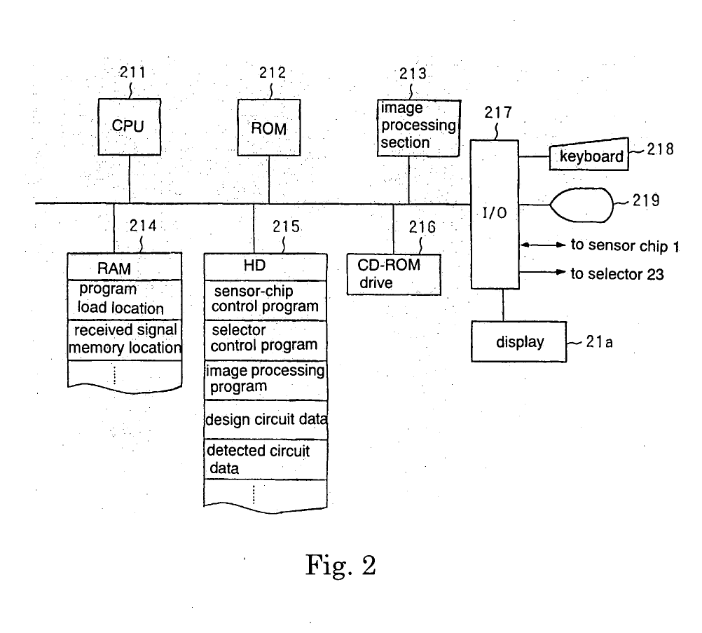

With reference to FIG. 2, the detailed configuration of the computer 21 will be described below. FIG. 2 is a block diagram showing the hardware configuration of the computer 21 in the inspection system.

The reference numeral 211 indicates a CPU for use in various calculations and controls, such as the entire control of the computer 21, and the reference numeral 212 indicates a ROM for storing fixed values and various programs to be executed on the CPU 211. The reference numeral 213 indicates an image-processing section for processing input digital data to create image data and processing the created image data to output on the display 21a, and the reference numeral 214 indicates a RAM serving as a temporary storage device. The RAM 414 includes a program load location for storing programs to be loaded from an after-mentioned HD 215, and a storage location for storing digital signals detected at the sensor chip 1. The digital signals received by the computer 21 are stored with respect to each of sensor-elements groups corresponding to the respective shapes of the circuit wirings.

The reference numeral 215 indicates a hard disk (HD) as an external storage device. The reference numeral 216 indicates a CD-ROM drive as a read device for a detachable recording medium. The reference numeral 217 indicates an input/output interface for interfacing with a keyboard 218 and/or a mouse 219 as an input device, the sensor chip 1 and the selector 23.

The HD 215 stores a sensor-chip control program, a selector control program and an image-processing program. These programs will be loaded on the program load location of the RAM 214, and executed on the CPU.

The HD 215 also stores image data representing the shape of the circuit wiring inspected by the sensor chip 1, and design image data representing the shape of a corresponding design circuit wiring. Image data from the sensor chip 1 may be stored on the basis of a sensor-element group corresponding to the shape of one of the circuit wirings, or may be stored on the basis of one frame of all of the sensor elements.

The sensor-chip control program, the selector control program, the image-processing program and the design image data representing the shapes of the design circuit wirings may be installed by storing them on a CD-ROM or, and reading this CD-ROM record information using the CD-ROM drive, or by storing them on another medium such as FD or DVD, and reading this record information, or by downloading via a networks.

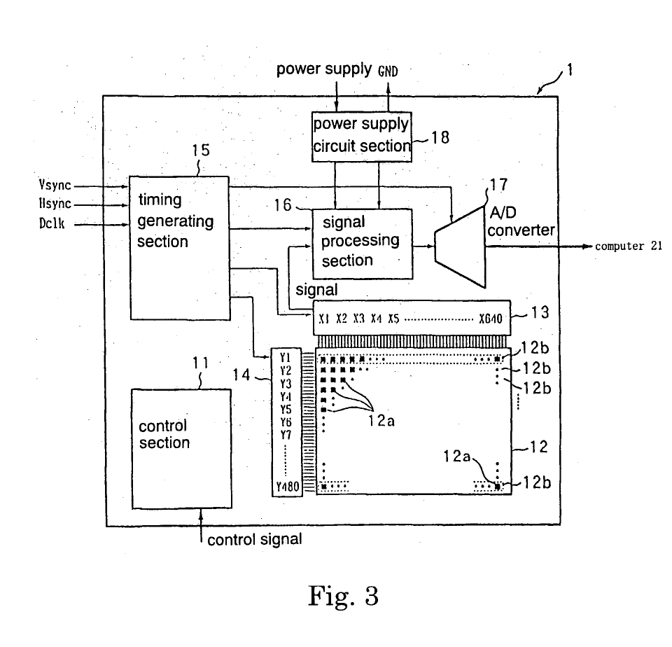

With reference to FIG. 3, the electrical configuration of the sensor chip 1 in the inspection system according to this embodiment will be described below.

The sensor chip 1 having the electrical configuration as shown in the FIG. 3 is mounted on a package (not shown).

The sensor chip 1 comprises a control section 11, a sensor element set 12 consisting of the plurality of sensor elements 12a composed of a plurality of transistors and an array of receiving electrodes, a vertical select section 14 for selecting at least one of sensor-element lines 12b each composed of a plurality of horizontally aligned sensor elements, a lateral select section 13 for picking up or reading out signals from the sensor elements 12a, a timing generating section 15 for generating a selection signal for selecting at least one of the sensor-element lines 12b, a signal processing section 16 for processing signals from the lateral select section 13, an A/D converter 17 for A/D converting signals from the signal processing section 16, and a power supply circuit section 18 for supplying electrical power for driving the sensor chip 1.

The control section 11 is operable to control the operation of the sensor chip 1 in accordance with the control signal from the computer 21. The control section 11 includes a control register for setting the operation timing of the sensor, an amplification factor and a reference voltage.

The sensor elements 12a are arranged in a matrix form, and operable to detect in a non-contact manner potential variation generated in each of the circuit wrings 101 in response to an inspection signal supplied from the corresponding probe 22 to the circuit wring 101.

The timing generating section 15 is supplied with the vertical synchronization signal (Vsync), the horizontal synchronization signal (Hsync) and a digital clock signal (Dclk) from the computer 21 to supply a timing signal for selecting specific ones of the sensor elements 12a, to the vertical select section 14, the lateral select section 13, the signal processing section 16 and the A/D converter 17.

The vertical select section 14 selects at least one row of the sensor element set 12 sequentially in accordance with the timing signal from the timing generating section 15. All of the detection signals of the sensor elements 12a in the sensor-element line 12b selected by the vertical select section 14 are output at once from these sensor elements 12a and are input into the lateral select section 13. The lateral select section 13 amplifies the analog detection signals output from 640 pieces of terminals, and then temporarily holds the amplified signals. Then, the lateral select section 13 outputs the analog signals sequentially to the signal processing section 16 in accordance with the timing signal generated by a selecting circuit composed of a multiplexer or the like in the timing generating section 15.

The signal processing section 16 further amplifies the analog signals from the lateral select section 13 to the level required for a determination processing, and performs an analog signal conditioning such as filtering for canceling noise. Then, signal processing section 16 transmits these signals to the A/D converter 17. The signal processing section 16 also includes an automatic gain control to automatically arrange the voltage amplification factor of the signals read from the sensor elements to an optimum value.

The A/D converter 17 converts the detection signals, which are detected by each of the sensor elements and transmitted from the signal processing section 16 in an analog form into the digital signals, for example, of 8-bit, and then outputs these digital signals. The power supply circuit 18 generates a reference clamp voltage for the signal processing section or the like.

While the A/D converter 17 is incorporated into the sensor chip 1 in this embodiment, the analog signals subjected to the analog signal conditioning in the signal processing section may be output directly to the computer 21.

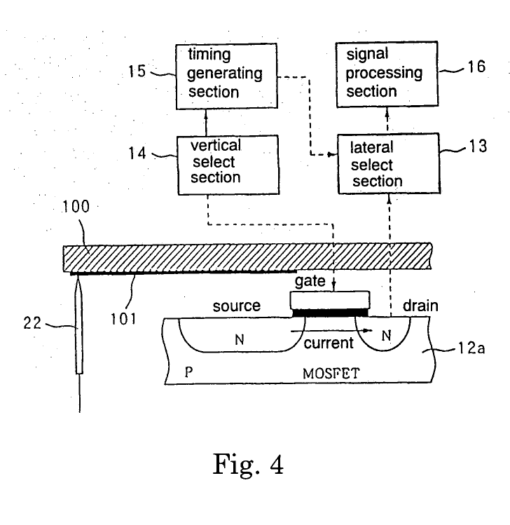

One specific example of the sensor chip 1 for use in the inspection system will be described below. FIG. 4 is an explanatory diagram of one of the sensor elements 12a composed of a semiconductor transistor.

The sensor element 12a is a MOS field effect transistor (MOSFET), in which one of diffusion layers is formed to have a lager surface area than that of the other diffusion layer. The diffusion layer having the larger surface area serves as a passive element, and this passive element is disposed in opposed relation to the circuit wiring 101. The passive element is formed continuously with a source of the MOSFET. The MOSFET also has a gate connected to the vertical select section 14, and a drain connected to the lateral select section 13. The diffusion layer serving as the passive element is also provided with a discharge potential barrier for discharging an unwanted charge.

When the sensor element 12a is selected by the timing generating section 15 through the vertical select section 14, a signal is transmitted from the vertical select section 14 to the gate to turn on the sensor element 12a (i.e. to bring the sensor element 12a into a state ready to output the detection signal).

At this moment, when a given voltage is applied to the circuit wiring 101 from the probe 22 as an inspection signal, the potential of the circuit wiring 101 is varied and thereby a current flows from the source to the drain. This current serves as the detection signal which is transmitted to the signal processing section 16 through the lateral select section 13. If no circuit wiring 101 exists at the position opposed to the sensor element 12a, no current will flow.

Thus, by analyzing the position of the sensor element 12a having the output current as the detection signal, it can be determined in what position of the circuit board 100 the circuit wiring 101 extending from its electrode in contact with the probe 22 is located.

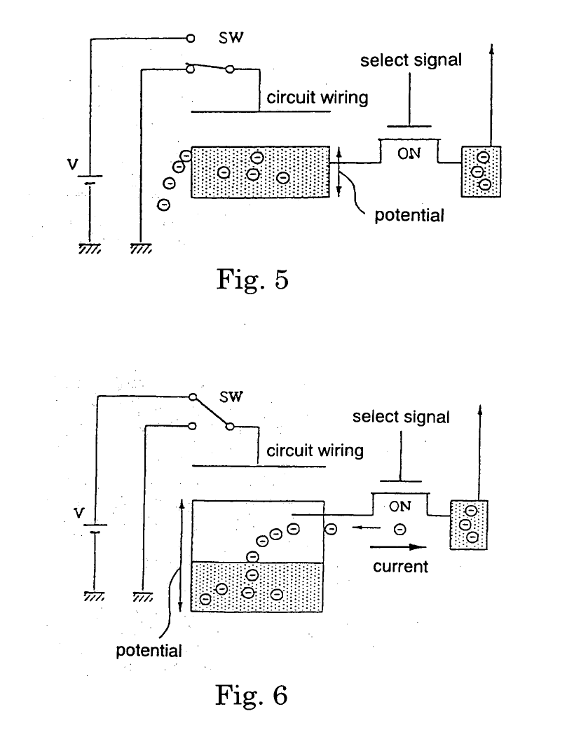

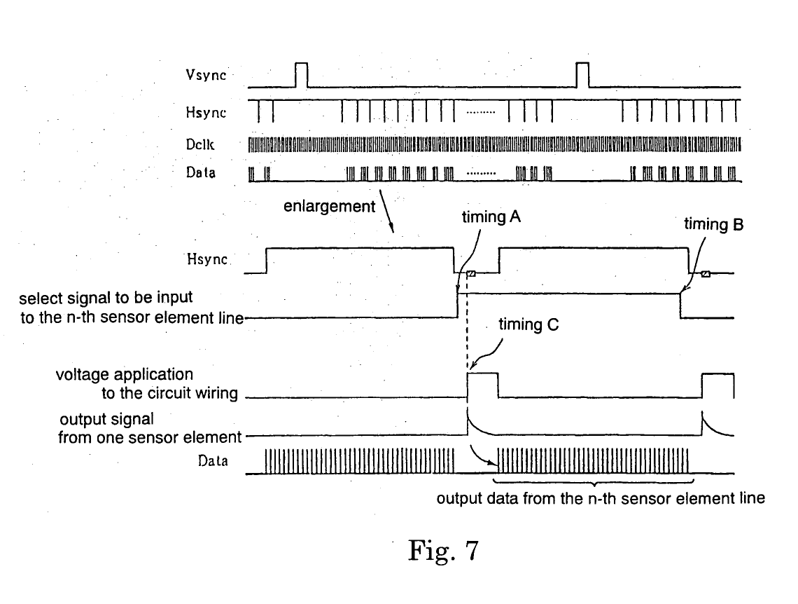

The principle of the current flow from the source to the drain will be described below in detail. FIGS. 5 and 6 are model diagrams for explaining this principle simply. FIG. 5 shows the state when no voltage is applied to the circuit wiring, and FIG. 6 shows the state when a given voltage is applied to the circuit wiring.

As shown in FIG. 5, if no voltage is applied to the circuit wiring, a surplus charge in the diffusion layer flows over from the discharge potential barrier having a lower potential than that of a potential barrier below the gate which is turned off. In this case, the potential of the source is defined by the potential of the discharge potential barrier.

As shown in FIG. 6, when a voltage V is applied to the circuit wiring, the circuit wiring is positively charged (at a potential V). Since the circuit wiring and the source-side diffusion layer are distanced at very close range, the source-side diffusion layer has the increased potential V by the influence of the potential variation in the circuit wiring, and thereby a charge flows into the source-side diffusion layer. That is, the source-side diffusion layer operates as if the circuit wiring and the source-side diffusion layer were capacitively coupled, so that the potential at the source-side diffusion layer is lowered to allow electrons to flow into the source-side diffusion layer or allow a current to flow from the source to the drain.

When the circuit wiring is connected to the ground again, the source-side diffusion layer gets back into the original potential, and thereby surplus electrons are released gradually from the discharge potential barrier.

<Signal Input/output timings in Sensor Chip>

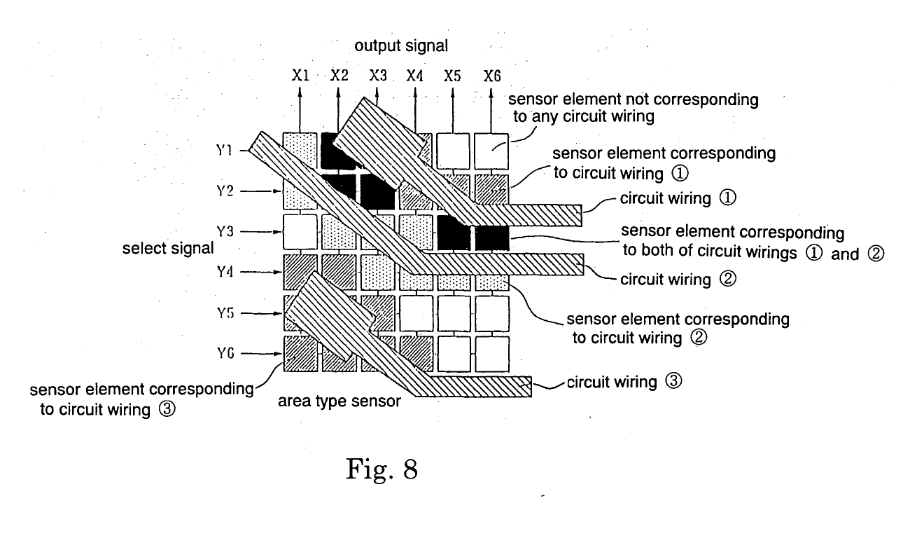

FIG. 7 is a timing chart showing input/output timings in the case of using a MOSFET as shown in FIG. 4.

The upper four lines show the Vsync, the Hsync, the Dclk and the output data from the sensor chip 1, respectively. The lower six lines show several enlarged Hsyncs and each of input/output signals in the sensor element generated during the course of these Hsyncs, respectively.

When the Vsync, Hsync and Dclk are input to the timing generating section 15 as shown in FIG. 7, the sensor chip 1 outputs data as shown by “DATA”.

More specifically, the timing generating section 15 starts counting the Dclk from the trailing edge of the n-th Hsync to control for the vertical select section 14 to transmit the selection signal to the n-th sensor-element line 12b at a given timing A. Then, the vertical select section 14 further counts the Dclk to keep transmitting the selection signal until a given timing B.

Concurrently, the computer 21 starts counting the Dclk from the trailing edge of the n-th Hsync to control for the selector 23 to apply the given voltage to the circuit wiring to be inspected, i.e. inspection circuit wiring, at a timing C which lies between the timings A and B.

The timing generating section 15 also controls for the lateral select section 13 to hold the detection signals from the n-th sensor-element line at the same timing as the timing C. The reason why this timing is set in the same as the timing C is that in case of using the MOSFET as shown in FIG. 4, the output from each of the sensor elements appears as an exponentially reducing current having a differential waveform of the voltage pulse applied to the circuit wiring.

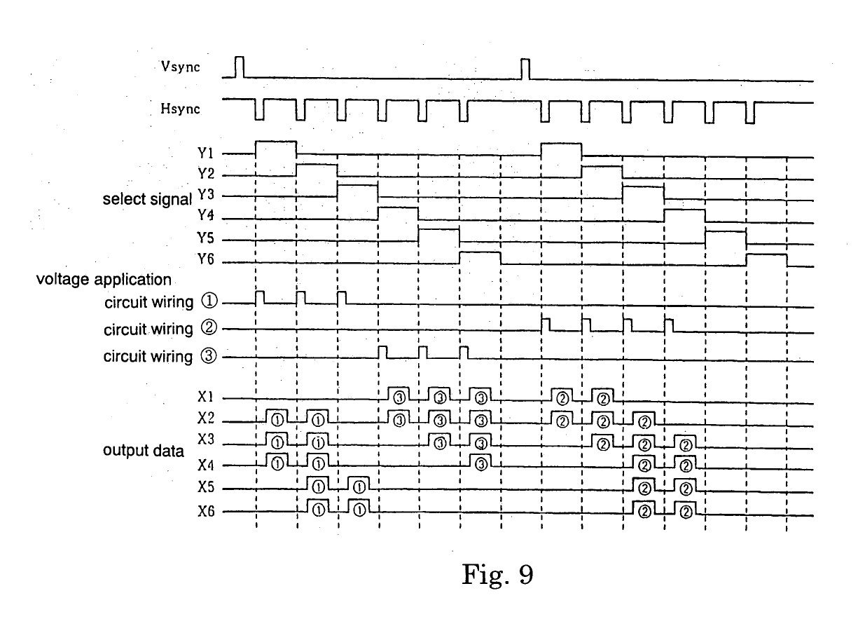

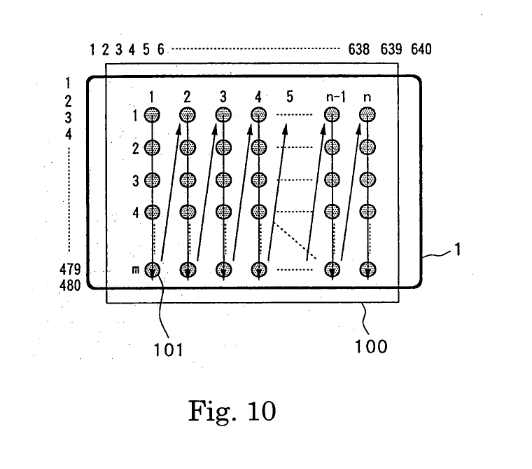

With reference to FIGS. 8 and 9, voltage application timings to three circuit wirings and corresponding output signals will be specifically described. FIG. 8 is an explanatory diagram of an inspection of the circuit wirings (1) to (3) by use of 6×6 sensor elements. FIG. 9 is an operational timing chart the inspection system.

As the sensor elements corresponding to the circuit wiring (1), there are 10 sensor elements which are positioned at the coordinates (X2, Y1), (X3, Y1), (X4, Y1), (X2, Y2), (X3, Y2), (X4, Y2), (X5, Y2), (X6, Y2), (X5, Y3) and (X6, Y3).

As the sensor elements corresponding to the circuit wiring (2), there are 14 sensor elements which are positioned at the coordinates (X1, Y1), (X2, Y1), (X1, Y2), (X2, Y2), (X3, Y2), (X2, Y3), (X3, Y3), (X4, Y3), (X5, Y3), (X6, Y3), (X3, Y4), (X4, Y4), (X5, Y4), and (X6, Y4).

As the sensor elements corresponding to the circuit wiring (3), there are 9 sensor elements positioned at the coordinates (X1, Y4), (X2, Y4), (X1, Y5), (X2, Y5), (X3, Y5), (X1, Y6), (X2, Y6), (X3, Y6), and (X4, Y6).

Among these sensor elements, the 5 sensor elements at the coordinates (X2, Y1), (X2, Y2), (X3, Y2), (X5, Y3) and (X6, Y3) illustrated by black color are used for both inspections of the circuit wirings (1) and (2). Thus, both of the circuit wirings (1) and (2) cannot be inspected simultaneously by driving the sensor elements only one time. In addition, both of the circuit wirings (2) and (3) are inspected by using the sensor elements on the sensor-element line of the coordinate Y4. Thus, when using the above process in which one row of the sensor-element line is simultaneously driven, both of the circuit wirings (2) and (3) cannot be inspected simultaneously by driving the sensor elements only one time. In contrast, such a problem will not be caused between the circuit wirings (1) and (3).

Thus, both of the circuit wirings (1) and (3) is first inspected within the time period required for driving each of the sensor elements once (one frame), and then the circuit wiring (2) will be inspected in the subsequent frame.

Accordingly, as shown by the timing chart in FIG. 9, data representing the shape of the circuit wiring (1), data representing the shape of the circuit wiring (3), and data representing the shape of the circuit wiring (3) will be output sequentially.

<Process of Applying Voltage to Plural Circuit Wirings>

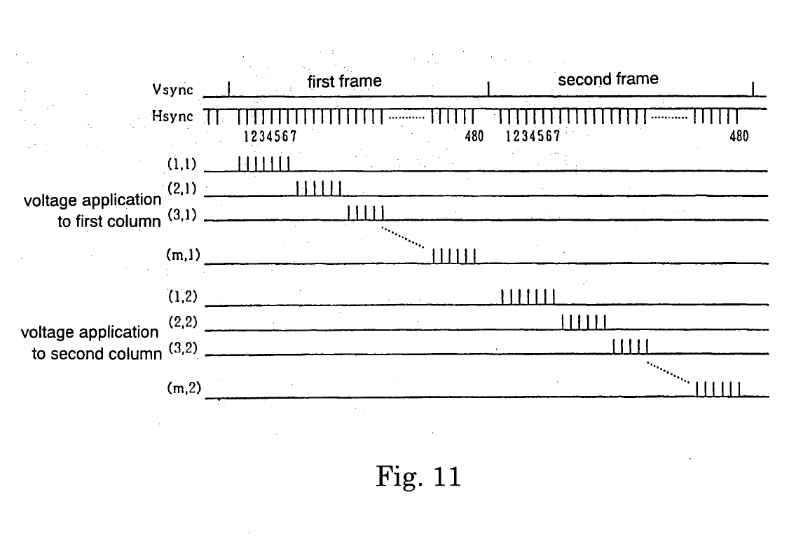

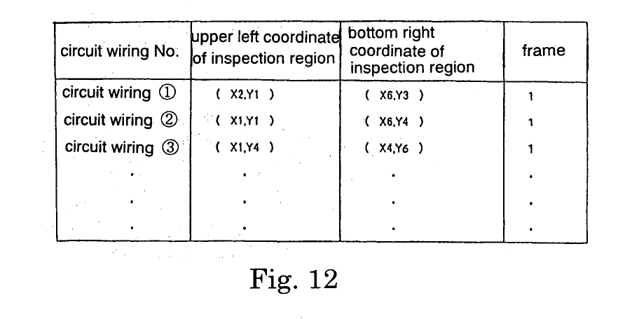

With reference to FIGS. 10 and 11, a process of efficiently applying voltage to a plurality of circuit wirings will be described below. FIG. 10 is an explanatory diagram of a sensor drive sequence (voltage supply sequence) to a plurality of circuit wirings formed on a single circuit board. FIG. 11 is a timing chart showing one example of voltage supply timings in the sensor drive control in FIG. 10.

For simplifying explanation, each of the target circuit wirings is indicated by ∘ in FIG. 10. The circuit wirings are generalized as a model arranged in a matrix form having m rows and n columns.

Fundamentally, during the time period of supplying voltage to one of the circuit wirings covered by the signal receiving region of the sensor, it is required to keep all of the remaining circuit wirings in a reference potential (GND). Because when the voltage is applied simultaneously to two target circuit wirings, there is a case where while one of the target circuit wirings includes a disconnection in the middle thereof, this circuit wiring with disconnection is short-circuited to the other target circuit wiring. In this case, the target circuit board will be improperly determined as an acceptable one, and the open or disconnection defect in the circuit wiring will be undesirably passed over.

A certain voltage is supplied to one of the circuit wirings once while driving one of the sensor-element lines. Thus, even if two or more of the circuit wirings are commonly covered by one of the sensor-element lines, the voltage can be applied to only one of the two or more circuit wirings

Thus, as illustrate, in the first frame, the voltage is applied to the circuit wirings aligned in the first column sequentially in the vertical direction from the upper side of the figure, or in order the first row, the second row, - - - , and the m-th row. In the second frame, the voltage is also applied to the circuit wirings arranged in the second column sequentially in the vertical direction from the upper side of the figure. Thus, in the n-th frame, all of the circuit wirings will be applied with the voltage.

Specific voltage supply timing is shown in FIG. 11. In response to each of the first Hsync to seventh Hsync in the first frame (in the interval from the first Vsync to second Vsync), the voltage is applied to the circuit wiring arranged in the first row and the first column or (1, 1).

Then, in response to each of the eighth Hsync to the fourteenth Hsync, the voltage is applied to the circuit wiring arranged in the second row and the first column or (2, 1). The voltage is further applied sequentially to the circuit wirings (3, 1), (4, 1), . . . ,(m, 1). Then, shifting to the second frame, the voltage is applied sequentially to the circuit wirings (1, 2), (2, 2), . . . ,(m, 2). Thus, the sensor elements are driven repeatedly until the entire circuit wirings are completely inspected, or until the inspection in the n-th frame are completed.

<Modeling of Circuit Wirings>

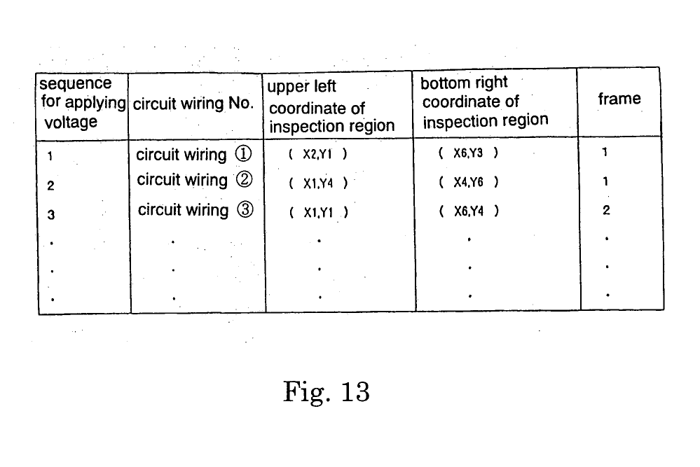

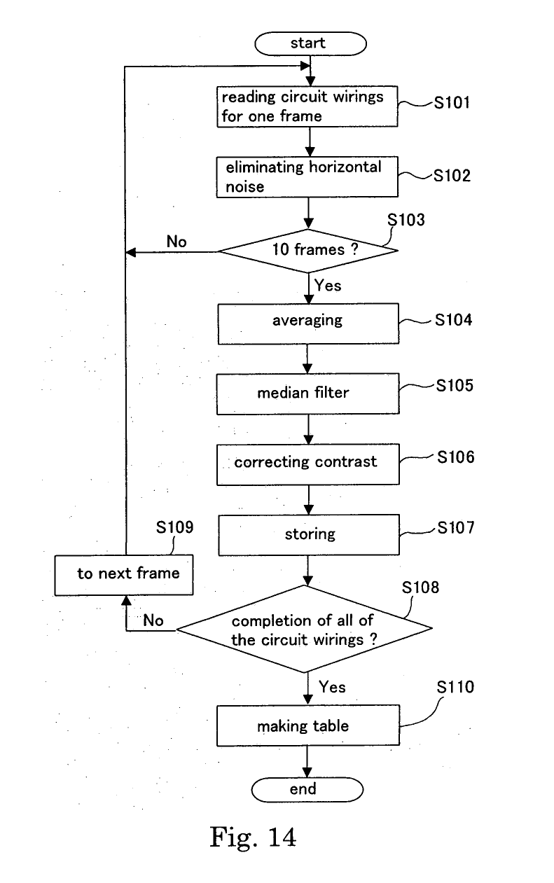

With reference to FIGS. 12 and 13, a process of modeling the circuit wirings in the matrix form as described above will be described below.

A region of the inspection circuit wiring is cut out in a rectangular shape from the shape data (e.g. CAD data) of the design circuit wirings to produce a table as shown in FIG. 12. In FIG. 12, each of the individual circuit wirings is uniquely numbered, and the uppermost and leftmost coordinate and the bottommost and rightmost coordinate of the rectangular region including each of the numbered circuit wirings are associated with the coordinates of the sensor element to indicate them on this table. The first frame is first selected for all of the numbered circuit wirings.

Then, the numbered circuit wirings are rearranged in order of smaller value in the upper left Y-coordinate. In FIG. 12, the first is the circuit wirings (1) and (2) each having the Y-coordinate Y1, and the second is the circuit wiring (3) having the Y-coordinate Y4.

Then, the upper left Y-coordinate value of each of the numbered circuit wirings is compared with the bottom right Y-coordinate value of each immediately preceding circuit wiring. When the former is smaller than the latter, the frame of the former is shifted to another one on the assumption that the sensor-element lines for reading these circuit wirings are overlapping.

In FIG. 12, the circuit wiring (1) is defined as a circuit wiring to which the voltage is first applied. Then, the upper left Y-coordinate of the circuit wiring (2) is compared with the bottom right Y-coordinate of the circuit wiring (1). In this case, the circuit wiring (1) is Y3, and the circuit wiring (2) is Y1, wherein Y3 is larger than Y1. Thus, the circuit wiring (2) is shifted to the second frame. Since the second frame is inspected after the first frame, the circuit wiring (2) is transferred to the lowest line of the table.

At this moment, the circuit wiring immediately preceding to the circuit wiring (3) is the circuit wiring (1). Then, the upper left Y-coordinate Y4 of the circuit wiring (3) is compared with the bottom right Y-coordinate Y(3) of the circuit wiring (1). Since Y4 is greater than Y3, the circuit wiring (3) remains in the first frame. Repeating the same steps, each frame for the circuit wiring (4), and all other circuit wirings will be defined as either one of the first and second frames. Through the above steps, each of the circuit wirings is grouped into either one of the first frame and the second frame.

The same steps are carried out in the group of the second frame. In this case, the upper left Y-coordinate value of the circuit wiring is compared with the bottom right Y-coordinate value of the immediately preceding circuit wiring to which the voltage is applied. Then, when the former is less than the latter, the circuit wiring having the less value is shifted to the third frame. If NO, the circuit wiring having the greater value is left in the second frame.

Through the above steps, the first, second and third frames are grouped. These steps are carried out as long as additional frame is required. When no additional frame is required, this process will be terminated.

As a result of the above process, the table as shown in FIG. 13 is produced. In this table, the frame numbers correspond to the column numbers shown in FIG. 10, and the numbers representing the sequence for applying a voltage to the circuit wirings within the same frame correspond to the row numbers shown in FIG. 10.

Referring to FIG. 13, in response to the first to third Hsyncs (see Y-coordinate) after the first Vsync, a voltage pulse is first applied to the circuit wiring (1), and then in response to the fourth to sixth Hsyncs, a voltage pulse is applied to the circuit wiring (3). Further, in response to the first to fourth Hsyncs after the second Vsync, a voltage pulse is applied to the circuit wiring (2).

In the above process, on the assumption that the shape data of the design circuit wiring completely corresponds to the coordinates of the sensor elements, the profile coordinates of the circuit wiring is simply defined as the coordinates of the sensor elements. However, some displacement is actually cased by mechanical superposition between the sensor and the circuit wiring. Thus, the above Y-coordinate for determining the region to be inspected may be set to provide a slightly wider region in consideration with the above displacement.

<Process for Image Processing>

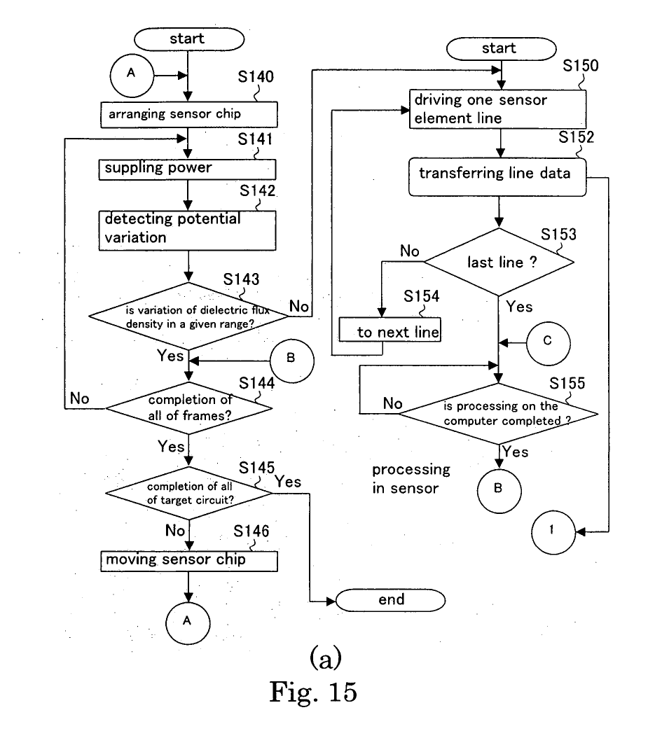

With reference to FIG. 14, a processing for extracting target data to be performed before the initiation of an actual inspection in the inspection system will be described below.

FIG. 14 is an explanatory flow chart of a processing for extracting target data from a gold sample in the inspection system.

At Step S101, on a circuit board of the gold sample, circuit wirings for one frame are inspected. Specifically, all of sensor elements are driven to pick up a digital data representing each shape of plural circuit wirings which can be made in a model arranged in one column.

At Step S102, horizontal noise is eliminated. This is performed by horizontally averaging the data corresponding to 10 dots on the left edge of the picked-up image and subtracting the averaged value from the value of the original entire image data.

At Step S103, it is determined whether the reading for 10 frames has been completed. If NO, the process returns to Step S101 to inspect the same circuit wiring again.

If the inspection for 10 frames is completed at Step 103, the process will proceed to Step S104. At Step S104, the image data for 10 frames is averaged. Then, at Step S105, the averaged data is passed through a median filter. By this processing, local noise is eliminated.

Then, after correcting contrast at Step S106, the profile data is stored in the RAM 214 of the computer 21 as the target data at Step S107.

At step S108, it is determined whether digital data for all of the circuit wirings on the gold sample has been picked up. If digital data for all of the circuit wirings are not fully extracted, and some un-inspected circuit wirings remain, the process proceeds to Step S109.

At Step 109, the first frame is shifted to the second frame to allow data on the un-inspected circuit wirings to be extracted. Thus, the process returns to Step 101. The processing from Step S101 to Step S107 will be carried out in the next frame.

By repeating the processing from Step S101 to Step S107, the extraction of the image data for all of the circuit wirings will be completed at Step 108. Thus, the image data for all of the circuit wirings has been picked up, and the process proceeds to Step S110 to make a table. This table shows the correlation between each of the circuit wirings and the range/the gradation thereof. After producing the table, the processing for extracting the target data is completed.

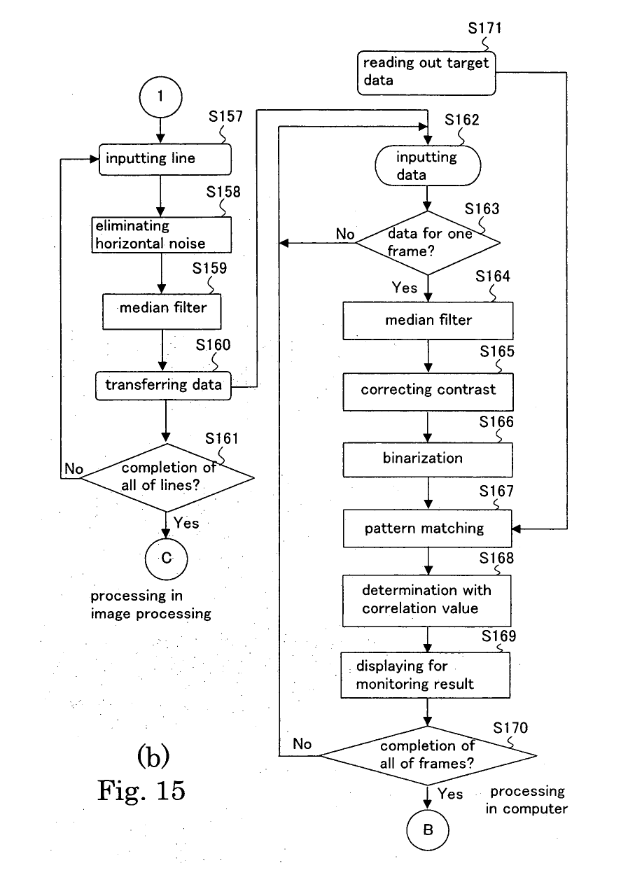

With reference to FIG. 15, an actual inspection control in the inspection system will be described blow. FIG. 15 is an explanatory flowchart of an inspection control in the inspection system.

At Step 140 in FIG. 15, the sensor chip 1 is arranged at an initial inspection position of a circuit board to be inspected, and the probe 22 is moved and brought into contact with the first target circuit wiring 101 to supply an inspection signal thereto.

Then, at Step S141, a power is supplied to the first target circuit wiring, and the non-target circuit wirings are connected through the probe 22, for example, to the ground level. At Step S142, potential variation (dielectric flux density) only in a portion of the target circuit wiring including a predetermined specific point is detected using the sensor chip. This detection processing corresponds to the detection processing for only a given sensor element in Steps S151 to 156 as described later.

This predetermined specific point corresponds to a detection point around the distal end of the target circuit wiring supplied with the power from the probe 22. That is, it is a detection point where if the supplied power reaches the position when the variation of dielectric flux density is detected at the position, it can be determined that the circuit wiring includes no disconnection between the power-received end and the position and where the sensor element is never brought to the ground level due to coupling with the non-target circuit wiring.

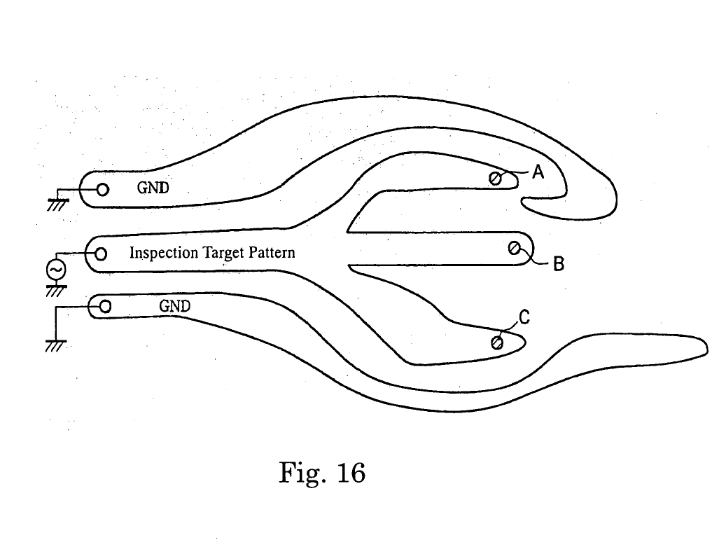

FIG. 16 shows one example of the specific point for the inspection control in the inspection system.

A circuit wiring designated by “target circuit wiring” in FIG. 16 has one end in contact with the probe 22 for supplying a power thereto. Each of two circuit wirings designated by “GND’ on both sided of the target circuit wiring has one end in contact with the probe 22 brought to the ground level.

The specific point or position may be set around the input/output end (distal end, or connection terminal to another circuit wiring) of the target circuit wiring, for example, A, B and C in FIG. 16. In this case, if an adequate dielectric flux density or potential variation is detected at the specific position, it can be determined that the target circuit wiring is normal. Otherwise, if an adequate dielectric flux density is not detected at the specific position (the supplied power does not reach the specific position, it is readily determined that the target circuit wiring includes a defect.

Thus, at Steps S143, it is determined whether the variation of dielectric flux density is in a given range, based on a detection result at S142. If the dielectric flux density falls within the given range, it will be determined that the target circuit wiring is normal, and the process will advances to Step S144. Then, at Step 145, it is determined whether all of the circuit wirings in opposed relation to the sensor chip 1 have been detected. Specifically, it is first checked whether of the circuit wirings in opposed relation to the sensor chip 1 have been detected in all of the frames. If NO, the process returns to Step S141. At Step S141, the power supply control and the ground level control are performed to detect voltage variation in the specific position of the next circuit wiring.

When it is determined that the circuit wirings in opposed relation to the sensor chip 1 have been detected in all of the frames, the process advances to Step 145, and it is checked whether all of the target circuit wirings have been detected. If YES, this detection processing will be terminated.

Otherwise, when it is determined that the target circuit wirings have not been completely detected, at Step S145, the process advances to Step S146, and the sensor chip 1 is moved and set up at a position, for example, of the adjacent circuit wiring. Then, the process returns to Step S140, and starts the inspection at a renewed sensor chip position.

At Step 143, when the variation of dielectric flux density in the specific position is in the given range, it is determined that some portion of the target circuit wiring includes a defect. Thus, the process advances to a circuit-wiring evaluation processing at Steps S151 and subsequent Steps.

Specifically, at Step S151, one of the sensor-element lines in the sensor chip 1 to be supposed to entirely cover the target wirings is driven. Then, at Step S152, obtained digital data are transmitted to the image-processing section 213 of the computer in increments of one sensor-element line.

At Step S153, it is determined whether the sensor-element line associated with the transmitted data is the last sensor-element line in one frame covering the target circuit wirings. If NO, the process will advances to a processing for the next sensor-element line.

When it is determined at Step S153 that the sensor-element line associated with the transmitted data is the last sensor-element line in the frame covering the target circuit wirings, the process advances to Step S155, and it is checked whether the processing on the computer is completed. If NO, the process waits until the computer completes the processing. Because the data must be finally received and processed by the computer.

When it is determined at Step S155 that the computer processing has been completed, the process advances to Step S144, and a processing for the next circuit wiring is performed.

In the system according to the first embodiment, the image-processing section is operable to enter the digital data for one sensor-element line to the computer 21 as shown in Step S157, in response to the line data transmission from the sensor chip 1 as shown in Step S152, and then horizontal noises are eliminated at Step S156.

While this process is similar to that in Step S102 in FIG. 14, it performs a median filter processing using a median filter at Step S159 after eliminating the noise without the averaging processing for 10 frames as in Steps S103 and S104.

Then, at Step S160, the processed digital data is transmitted to and stored in the RAM 214 of the computer 21.

At Step S161, it is determined whether data on all of the sensor-element lines in the entire frame have been stored in the RAM 214. If data of the sensor-element lines corresponding to the target circuit wirings (required lines) have not been transmitted, the process returns to Step S157, and repeats Steps S157 to S161.

Otherwise, if it is determined at Step S161 that the processing of the sensor-element lines corresponding to the target circuit wirings (required lines) have been completed, the operation in the image-processing section 213 is terminated. Thus, process advances to Step S155.

When the computer 21 receives from the image-processing section 213 data corresponding to the processing at Step S160, it processes the potential variations in the target circuit wirings in a visible pattern at Step S162 and subsequent Steps

Specifically, at Step S162, the processed data from the image-processing section 213 are entered and stored in the RAM 214. Then, at Step S163, it is determined whether the data for one frame has been stored in the RAM 214. If NO, the data input processing at Step S162 will continue.

When it is determined at Step S163 that the data for one frame has been stored, the process advances to Step S164, and the entire stored image data is subjected to a median filter processing using a median filter.

At Step S165, the filtered data is corrected in contrast. Then, at Step S166, the data is binarized, and then the profile of the subject is traced.

The process advances to Step S167, and the image data are compared with target data, which is obtained by the processing as shown in FIG. 14, through a least squares method. At Step S168, the correlation value between the above two data is calculated.

Then, at Step S169, the comparison result is displayed on the display 21 a in such a manner that the difference between the image data and the target data can be visibly recognized. This allows an operator to visually check the state of the target circuit wirings in the frame.

At Step S170, it is determined whether the processing for required frame has been completed. If NO, the process returns to Step S162, and the above processing will be repeated until the results of the required frame is completely displayed, to compare between the target data and the image data for the entire frame related to the target circuit wirings, and display the comparison result.

Otherwise, when it is determined at Step S170 that the processing for required frame has been completed, the process advances to Step S144. In this case, a specific circuit wiring to be supposed to have a defect is displayed on a display screen to allow an operator to visually check the state of the circuit wiring.

As described above, according to the first embodiment, considering that the profile tracing at Step S151 and subsequent Steps in FIG. 15 is required to take time, the variation of dielectric flux density in a specific position is detected and checked in Steps S140 to S146 while skipping the profile trace, and the profile tracing is performed only if a certain defect is found. Thus, a high-speed inspection can be achieved while reliable performing required inspections on defects. Further, the need for checking the entire region of a target circuit wiring in all cases can be eliminate, and a highly efficient inspection can be achieved by checking only a specific portion of the target circuit wiring to be supposed to have a defect.

In the first embodiment, the acceptability of circuit wirings is determined in accordance with image data only when needed, so that an accurate determination on acceptability can be made without excessive load. Further, the inspection result can be displayed as images to allow operator to intuitively figure out the shape of the circuit wiring and readily recognize a defective portion. Furthermore, even if a pliability of circuit wirings are formed on a single circuit board, an image processing can be performed only when needed to provide an excellent inspection system with minimized complicate image processing.

While the sensor elements 12a in the sensor chip 1 is two-dimensionally arranged in conformity with the shape of the circuit board 100, they may be three-dimensionally arranged.

Preferably, the sensor elements 12a have a uniform shape as shown in FIG. 3. This is intended to allow the respective sensor elements 12a to supply the inspection signal to the circuit wiring and receive the signal generated in the circuit wiring, without any deviation.

As shown in FIG. 3, the sensor elements 12a is preferably arranged in the row and column directions at even intervals or. in a matrix arrangement. This makes it possible to reduce the unevenness in the number of the sensor elements 12a per a unit area opposed to the circuit wirings and to clarify the positional relationship between the sensor elements 12a so as to readily specify the shape of the circuit wiring based on the detection signals. Depending on the shape of a target circuit wiring, the sensor elements may also be arranged only in a single line.

While the sensor elements 12a in the sensor chip I are arranged in 480 rows×640 columns, this has been expediently selected for this embodiment, and 200,000 to 2,000,000 of sensor elements may be arranged in an area of 5 to 50 μm². In order to achieve an accurate inspection, it is preferable to set the interval or pitch of sensor elements 12a in conformity with the line width of a circuit wiring.

While N-channel MOSFET is used as the sensor element herein, the present invention is not limited thereto, but P-channel MOSFET may also be used. Further, while the passive element is formed as the n-type diffusion layer, the present invention is not limited thereto, but any other suitable material having relatively high conductivity, such as amorphous semiconductors, may be used. Furthermore, a conductor plate may be in ohmic contact with the surface of the source-side diffusion layer serving as the passive element. Thus, the electrical conductivity of the surface of the passive element can be increased, or a signal charge can be concentrated in the vicinity of the surface of the passive element to provide increased density of the signal charge, and enhanced capacitive coupling. In this case, the conductor plate may be formed of a metallic film or a polycrystalline semiconductor.

The sensor element may be a charge-voltage conversion circuit in which a diffusion layer of the semiconductor serves as an element for receiving signals from a circuit wiring. In this case, the detection signal may be picked up in the form of an amplified voltage so as to discriminate the detection signal more clearly. This allows the inspection of the circuit board to be performed with a higher degree of accuracy. A Bipolar transistor may also be used as the sensor element to output the detection signals accurately at a high speed. A thin-film transistor, such as TFT, may also be used as the sensor element to provide enhanced productivity of the sensor element and to increased array area of the sensor elements.

Additionally, a charge transfer element may be used as the sensor element. The charge transfer element may include a CCD. In this case, a charge-readout MOSFET may be used as the transistor. Then, the passive element may be formed continuously with a diffusion layer serving as a source of the charge-readout MOSFET, and the selection signal may be input into a gate of the charge-readout MOSFET to reduce a potential barrier formed below the gate. Further, a signal charge residing in the source may be transferred to a drain of the charge-readout MOSFET as a charge for the detection signal, and then the detection signal may be transferred by the charge-transfer element connected to the drain.

Furthermore, a charge-supply MOSFET for supplying a charge to the passive element in response to the potential variation in the conductive pattern and forming a potential barrier not to cause the backflow of the supplied charge before completing the potential variation in the conductive pattern may be provided, and a drain of the charge-supply MOSFET may be formed continuously with the diffusion layer serving as the passive element to provide a stable charge transfer. Using the charge-transfer element will also eliminate the need for providing a switching circuit, such as a multiplexer, to the lateral select section.

The sensor elements may be provided on a board of any material other than conductive materials, such as glass, ceramics, glass epoxy or plastics, and formed of any material capable of receiving electromagnetic waves radiated from the circuit wiring applied with the inspection signal, such as a material having a relatively high conductivity, metallic film, polycrystalline semiconductor, or an amorphous semiconductor.

While the first embodiment is arranged to detect the voltage variation in the circuit board, it may also be arranged to detect the magnitude of the electromagnetic waves radiated from the circuit wiring and the radiation shape thereof. If a given magnitude and shape of the electromagnetic waves are detected, it will be determined that the continuity of the circuit wiring is normally. If a lower magnitude and a different shape of the electromagnetic waves with respect to a given criterion are detected, it will be determined that the circuit wiring has some disconnected portion or chipped portion.

Further, while the first embodiment is arranged to bring the probe into contact with the end of the circuit wiring, a non-contact terminal may also be used to input the inspection signal from the starting point of the circuit wiring. The sensor chip may be a line-type sensor in which the sensor elements are arranged in one line. In this case, a given region of the circuit wirings may be inspected by moving the sensor chip vertically. When the inspected circuit wirings on the circuit board are larger than the array of the sensor elements, an area-type sensor may also be used and mechanically moved.

If the shape of the circuit wirings is considerably run off the edge of the signal receiving region of the sensor, each data received at different positions of the sensor elements may be saved and then combined.

While the first embodiment is arranged to simultaneously drive one sensor-element line, the present invention is not limited to this manner, and a plurality of sensor-element lines or a plurality of sensor elements in an area shape or non-line shape may be simultaneously driven. In such cases, if a plurality of sensor element groups opposing to the shape of the inspection circuit wiring are overlapped with a part of the sensor element groups opposing to the shape of another circuit wiring, the timing for applying a voltage to said another circuit wiring is also set in a selected period in a different frame.

As described above, according to the first embodiment, dielectric flux density in a specific position of a circuit wiring is first detected to determine the adequacy or acceptability of the circuit wiring. Referring to the detection result, an image of the circuit wiring is displayed, and utilized to determine the adequacy or acceptability of the circuit wiring. Thus, when needed, a reliable circuit-wiring inspection can be achieved while simplifying and facilitating high-speed processing.

### SECOND EMBODIMENT

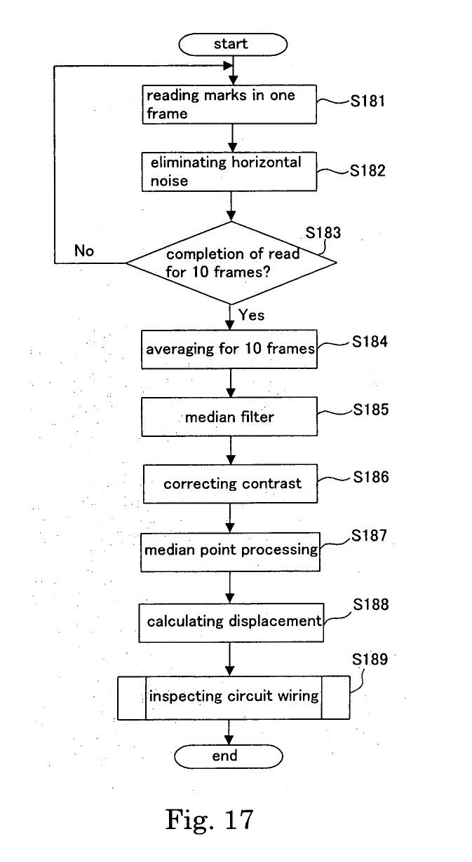

With reference to FIG. 17, an inspection system as a second embodiment of the present invention will now be described. FIG. 17 is a flowchart showing a processing of performing a preliminary inspection and measuring a positional displacement before initiating an inspection according to the second embodiment of the present invention.

The inspection system of this embodiment is different from the first embodiment in that an inspection circuit wiring is not compared with the gold sample but with a design image data (e.g. CAD data). Since other points are the same as those of the first embodiment, the description will be omitted, and the same components will be defined by the same reference numerals in the figure.

At Step S181, two or three circuit wirings on a circuit board as an inspection subject are inspected in one frame as pre-processing circuit wirings (marks). Specifically, an image data is formed which represents the shapes of 2 or 3 marks provided with leaving a distance vertically therebetween on the circuit board.

At Step S182, horizontal noise is eliminated. This is performed by horizontally averaging the data corresponding to 10 dots on the left edge of the picked-up image and subtracting the averaged value from the value of the original entire image data.

At Step S183, it is determined whether the marks have been repeatedly read 10 times. If not completed, the process returns to Step S181 to repeat reading the marks. When the inspection for 10 frames is completed, the process will proceed to Step S184.

At Step S184, the image data for 10 frames are averaged, and then the averaged data is passed through a median filter at Step S185 to eliminate local noise.

At Step S186, contrast is corrected. Then, the median point of the mark image is obtained at Step S187, and the displacement (coordinate displacement and angular displacement) between the median point of the mark image and the median point of the mark in the design image data (e.g. CAD data) is obtained at Step S188.

At Step S189, the actual inspection and image processing are carried out. In this step, the position of the generated image data is corrected based on the displacement value obtained at Step S188. The data processing in the actual inspection is substantially the same as that shown in FIG. 15, but is different only in that a coordinate transformation processing for one line data is inserted between Step S149 and Step S160.

According to the second embodiment, in an actual inspection, the generated image data can be accurately compared with the design image data representing the design circuit wirings, and thereby defects in the circuit wirings 101, such as disconnection, short-circuit and chipping, can be detected with a high degree of accuracy.

### THIRD EMBODIMENT

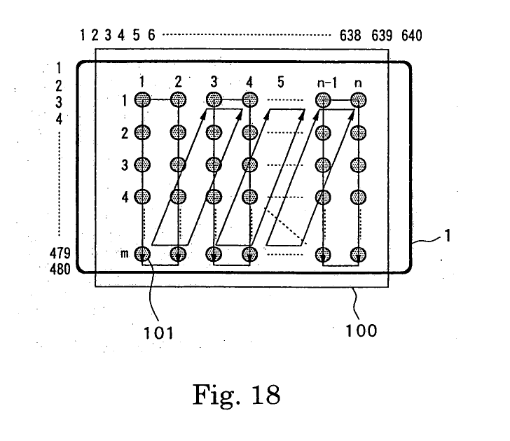

With reference to FIGS. 18, 19 and 20, an inspection system as a third embodiment of the present invention will now be described. The inspection system of the third embodiment is different from the first embodiment in that two adjacent circuit wiring lines are inspected simultaneously within one frame. Since other points are the same as those of the first embodiment, the description will be omitted herein and the same components will be defined by the same reference numerals in the Figure.

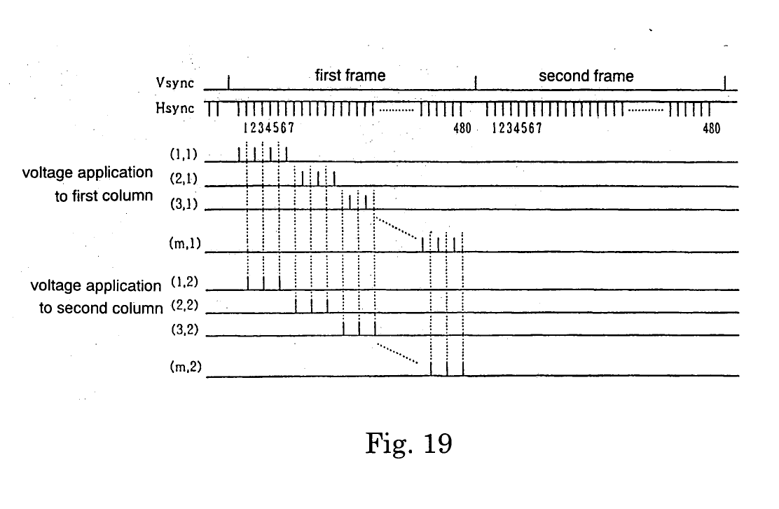

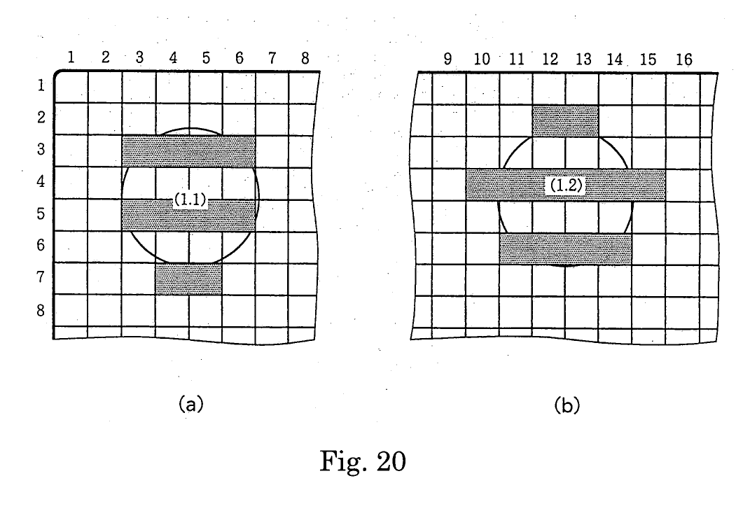

FIG. 18 is an explanatory diagram of a voltage supply sequence to a plurality of circuit wirings formed on a circuit board. FIG. 19 is a timing chart showing an example of the voltage supply timing,to the circuit wirings shown in FIG. 18. FIG. 20 is a diagram showing an output image obtained when a voltage is supplied at the timing in FIG. 19.

In FIG. 18, for simplifying the description as with FIG. 10, the inspection circuit wirings are indicated by ∘ and arranged in a matrix form of m rows×n columns.

As shown in the FIG. 18, according to this embodiment, in the first frame, the voltage is applied to the circuit wirings aligned in the first and second columns sequentially in the vertical direction of the Figure from above, or in order the first row, the second row, - - - , and the m-th row. In the second frame, the voltage is also applied to the circuit wirings arranged in the third and fourth columns sequentially in the vertical direction of the Figure from above. Thus, in the n/2-th frame, all of the circuit wirings will be applied with the voltage.

FIG. 19 is a timing chart showing an example of the timing for applying the voltage to the circuit wirings shown in FIG. 18.

As shown in this FIG. 19, in response to each of the first, third, fifth and seventh Hsyncs in the first frame (in the interval from the first Vsync to second Vsync), the voltage is applied to the circuit wiring arranged in the first row and the first column or (1, 1). Then, in response to each of the second, fourth, sixth and eighth Hsyncs, the voltage is applied to the circuit wiring arranged in the first row and the second column or (1, 2). Further, in response to each of the ninth, eleventh, - - - Hsyncs, the voltage is applied to the circuit wiring arranged in the first column, and then in response to each of the tenth, twelfth, - - - Hsyncs, the voltage is applied to the circuit wiring arranged in the second column (1, 2).

In the same manner, the voltage is applied in the second and succeeding frames. Specifically, the voltage is applied to the circuit wirings in the odd columns in response to the odd Hsyncs, and the voltage is applied to the circuit wirings in the even columns in response to the even Hsyncs.

That is, the timing for inputting the selection signal, the timing for detecting the voltage variation from the sensor-element line, and the timing for supplying the inspection signal to the circuit wirings are controlled to drive the sensor elements in the odd lines so as to detect the circuit wirings in the first column and to drive the sensor elements in the even lines so as to detect the circuit wirings in the second column.

In other words, the timing for applying the voltage to one circuit wiring is provided to skip over one sensor-element line, or at the interval of one sensor-element line. The image data will appears by skipping over one sensor-element line.

As a result, the image for each of the circuit wirings in the odd columns is displayed only by the odd sensor-element lines (FIG. 20(a)), and the image for each the circuit wirings in the even columns is displayed only by the even sensor-element lines (FIG. 20(b)).

In this manner, by applying the voltage alternately to the circuit wirings in the odd columns and the circuit wirings in the even columns in a same frame, the inspection time can be shortened half. The profile of the entire circuit wiring can be obtained by processing the image data and interpolating vacant lines.

Further, depending on the resolution of the sensor elements, the inspection of the circuit wirings in the plural columns may be performed within one frame period. For example, when the inspecting of the circuit wirings in five columns is performed within one frame period, the voltage may be applied to the same circuit wiring at every 5 Hsyncs.

### FORTH EMBODIMENT

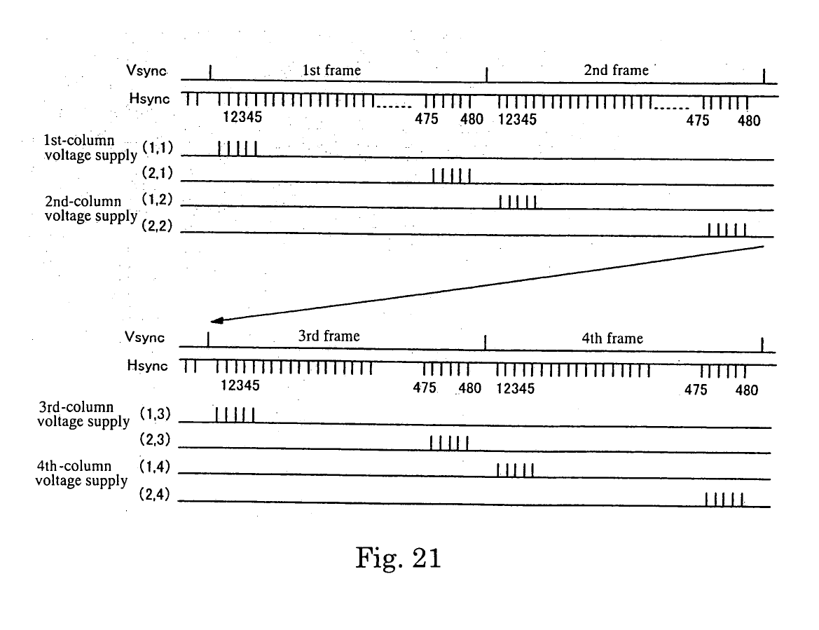

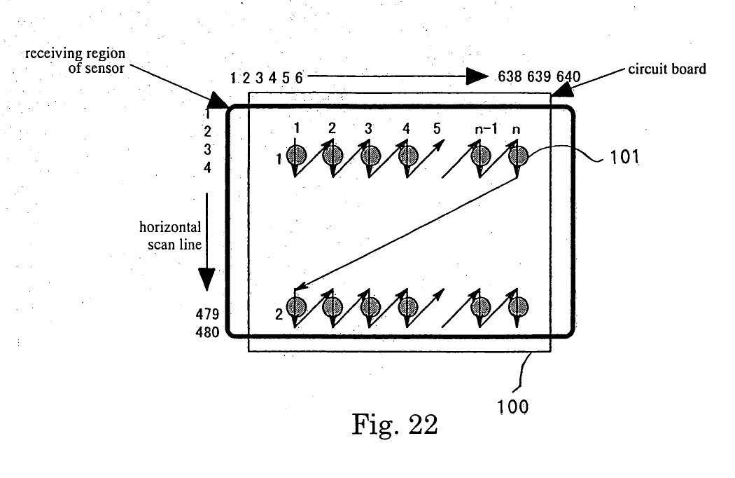

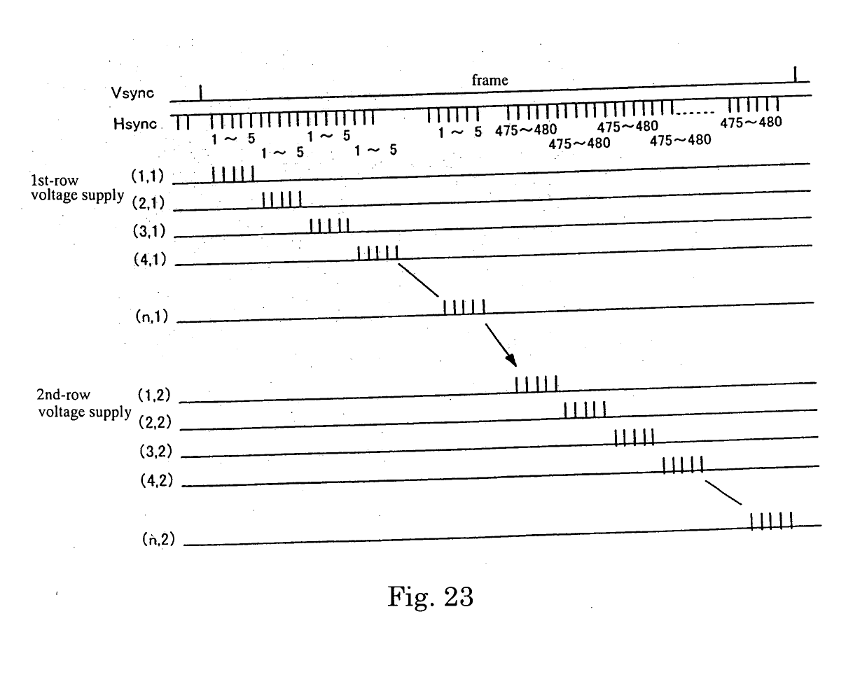

With reference to FIGS. 21, 22 and 23, an inspection system as a forth embodiment of the present invention will now be described. FIG. 21 is an explanatory timing chart of one example of input/output timings for inspecting circuit wirings arranged in two lines based on the sensor element control according to the first embodiment in FIG. 10. FIG. 22 is an explanatory diagram of a sensor drive sequence to a plurality of circuit wirings formed in a single circuit board, in an inspection system according the fourth embodiment of the present invention. FIG. 23 is an explanatory timing chart of one example of input/output timings in case where MOSFET is used as a sensor chip in the inspection system according to the fourth embodiment.

The inspection period of the inspection system of the fourth embodiment is reduced by the following control. In the following description, the same configurations or elements as those in the aforementioned embodiments are defined by the same reference numeral, and their description will be omitted.

The timing chart in FIG. 21 shows one example of an inspection control for circuit wirings arranged in two lines, based on the sensor drive sequence according to the first embodiment in FIG. 10. In FIG. 21, when circuit wirings are arranged in two lines, the number n of circuit wirings are aligned horizontally between 1st and 5th sensor-element lines. Further, no circuit wiring exists between 6th and 475th sensor-element lines, and the number n of circuit wirings are aligned horizontally between 476th and 480th sensor-element lines.

If a frame is assigned for each of columns according to the control process in the first embodiment, the voltage supply timing will be controlled as shown in FIG. 22. In FIG. 22, a voltage is supplied to the circuit wiring (1, 1) and the circuit wiring (2, 1) in the 1st frame, and the circuit wiring (1, 1) and the circuit wiring (1, 2) in the 2nd frame.

In each of the frames, the 1st to 480th sensor-element lines are sequentially driven in synchronous with a Hsync signal in the same manner. Thus, the period having no target circuit wiring, or the inspection period for 6th to 475th sensor-element lines, becomes useless time. For example, giving n=10, it is required to take a time for driving 480 lines×10=4800 lines.

In terms of inspection performances, it is critical to reduce an inspection time. In the fourth embodiment, only the sensor-element lines corresponding to target circuit wirings are selectively driven. Specifically, a Y decoder circuit of a random access memory is controlled to drive only the required sensor-element lines randomly and selectively so as to provide reduced inspection time.

The sensor-element lines corresponding to the target circuits wiring may be determined by obtaining pre-registered information about the target circuit wirings or by reading a standard pattern of the target circuit wirings to recognize the positions of the target circuits. The method of obtaining positional information about the target circuits is not limited to a specific one.

Based on the above concept, in the fourth embodiment, only the sensor-element lines corresponding to the target circuit wirings arranged in two lines are selectively driven in the order as indicated by the arrows in FIG. 22. FIG. 22 shows an example where the number n of circuit wirings are aligned horizontally between the 1st and 5th sensor-element lines. In the process in FIG. 22 according to the fourth embodiment, the sequence for supplying voltage to the circuit wirings in the 1st row is set in the horizontal direction, or in the order of from (1, 1) to (1, n). In the same manner, after the completion of voltage supply for the 1st row circuit wirings, a voltage is supplied to the circuit wirings in the 1st row in the order of from (2, 1) to (2, n).

Specific timings of the above drive control will be described with reference to FIG. 23. four sensor chips are matched, the inspection time can be reduced one-quarter.

In synchronous with 1st to 5th Hsync signals, the 1st to 5th sensor-element lines are selected, and a voltage is supplied to the circuit wiring (1, 1). Then, in synchronous with 6th to 10th Hsync signals, the 1st to 5th sensor-element lines are re-selected, and a voltage is supplied to the circuit wiring (1, 2).

Further, in synchronous with 11th to 15th Hsync signals, the 1st to 5th sensor-element lines are selected three times, and a voltage is supplied to the circuit wiring (1, 3). In the same manner, the voltage supply control is continuously performed up to the circuit wiring (1, n).

If n=10, in synchronous with 51st to 55th Hsync signals, the 476th to 480th sensor-element lines are selected, and a voltage is supplied to the circuit wiring (2, 1). In the same manner, the voltage supply control is continuously performed.

As described above, when n=10, the drive control process in the aforementioned embodiments is required to take a time for driving 4 800 of sensor-element lines. In contrast, according to the process in the fourth embodiment, the inspection can be completed within a time for driving 5 lines (Hsync)×20=100 lines.

That is, in the fourth embodiment, no sensor-element lines between the 1st-row circuit wirings in and the 2nd-row circuit wirings is driven. Thus, the inspection time can be significantly reduced.

### INDUSTRIAL APPLICABILITY

According to an inspection apparatus and method of the present invention, dielectric flux density in a specific position of a circuit wiring is first detected to determine the acceptability of the circuit wiring. Then, referring to the detection result, an image of the circuit wiring is displayed, and utilized to determine the acceptability of the circuit wiring. Thus, when needed, a reliable circuit-wiring inspection can be achieved while simplifying and facilitating high-speed processing. Further, the inspection apparatus and method allows an operator to determine or recognize or the acceptability or shape of a circuit wiring readily and viscerally.

What is claimed is:

1. An inspection apparatus for inspecting a circuit wiring on a circuit board, comprising:
supply means for supplying an inspection signal to said circuit wiring;
detecting means for detecting potential variation which is generated in said circuit wiring in response to said inspection signal, by use of a plurality of sensor elements; and
inspection control means for controlling said detecting means to detect the potential variation at a specific position of said circuit wiring, wherein if said detected potential variation at said specific position is out of a given range, said inspection control means is operable to control said detecting means to detect the potential variation which is generated in said circuit wiring in response to said inspection signal, by use of said plurality of sensor elements.

2. An inspection apparatus for inspecting a circuit wiring on a circuit board, comprising:
supply means for supplying an inspection signal to said circuit wiring;
detecting means for detecting potential variation which is generated in said circuit wiring in response to said inspection signal, by use of a plurality of sensor elements;
image-data creating means for creating image data representing the shape of said circuit wiring in accordance with positional information from one or more of said plurality of sensor elements which have sensed said potential variation; and
inspection control means for controlling said detecting means to detect the potential variation at a specific position of said circuit wiring, wherein if said detected potential variation at said specific position is out of a given range, said inspection control means is operable to control said image-data creating means to create said image data.

3. The inspection apparatus as defined in claim 1 or 2, wherein said circuit wiring is formed on said circuit board in a plural number, wherein said supply means is operable to supply said inspection signal to each of said circuit wirings at a different timing.

4. The inspection apparatus as defined in claim 1 or 2, which further includes selecting means for generating a selection signal to selectively drive only a part of said plurality of sensor elements.

5. The inspection apparatus as defined in claim 4, wherein said plurality of sensor elements are formed in a matrix arrangement,
wherein said selecting means is operable to input said selection signal simultaneously to one of a plurality of horizontal sensor-element lines of said sensor elements formed in said matrix arrangement, and
said detecting means is operable to simultaneously detect the potential variation from the sensor elements of said one sensor-element line located in opposed relation to at least a portion of said circuit wiring.

6. The inspection apparatus as defined in claim 5, wherein said circuit wiring includes a first circuit wiring and a second circuit wiring,
wherein said selecting means is operable to input said selection signal in turn to said plurality of sensor-element lines so as to drive all of said sensor elements,
said inspection control means is operable to control said detecting means to detect the potential variation from all of said sensor elements in synchronous with the input timing of said selection signal from said selecting means, and
said supply means is operable to supply said inspection signal to said first and second circuit wirings within the same frame (wherein one frame is a time period required for driving each of said plurality of sensor elements once) if no common sensor-element line is included between a first group of the sensor-element lines capable of detecting the potential variation in said first circuit wiring, and a second group of the sensor-element lines capable of detecting the potential variation in said second circuit wiring, and to supply said inspection signal to said first and second circuit wirings, respectively, in different frames, if one or more common sensor-element lines are included between said first and second groups of the sensor-element lines.

7. The inspection apparatus as defined in claim 4, wherein said plurality of sensor elements are formed in a matrix arrangement including a plurality of sensor-element lines,
wherein said selecting means is operable to selectively drive only one or more of said sensor-element lines corresponding to the circuit wiring to be inspected, and
said detecting means is operable to simultaneously detect the potential variation from the sensor elements of said one or more sensor-element lines located in opposed relation to at least a portion of said circuit wiring.

8. The inspection apparatus as defined in claim 1 or 2, wherein said specific position of said circuit wiring is set around the input/output end of said circuit wiring.

9. An inspection method for inspecting a circuit wiring on a circuit board, comprising Steps of:
supplying an inspection signal to said circuit wiring; and
detecting potential variations which is generated in said circuit wiring in response to said supplied inspection signal, by use of a plurality of sensor elements,
wherein said detecting step includes detecting the voltage variation at a specific position of said circuit wiring while supplying said inspection signal to said circuit wiring, wherein said potential variation generated in said circuit wiring in response to said inspection signal is detected using said plurality of sensor elements only if said detected potential variation at said specific position is out of a given range.

10. An inspection method for inspecting a circuit wiring on a circuit board, comprising the steps of:
supplying an inspection signal to said circuit wiring;
detecting potential variation which is generated in said circuit wiring in response to said supplied inspection signal, by use of a plurality of sensor elements; and
creating image data representing the shape of said circuit wiring in accordance with positional information from one or more of said plurality of sensor elements which have sensed said potential variation,
wherein said detecting step includes detecting the potential variation at a specific position of said circuit wiring while supplying said inspection signal to said circuit wiring, and
said creating step includes creating said image data if said detected potential variation at said specific position is out of a given range, while omitting the generation of said image data if said detected potential variation at said specific position falls within said given range.

11. The inspection method as defined in claim 9 or 10, wherein said circuit wiring is formed on said circuit board in a plural number, wherein said supplying step includes supplying said inspection signal to each of said circuit wirings at a different timing.

12. The inspection method as defined in claim 9 or 10, which further includes Step of selectively driving only a part of said plurality of sensor elements corresponding to said circuit wiring.

13. The inspection method as defined in claim 12, wherein said plurality of sensor elements are formed in a matrix arrangement,
wherein said driving step includes supplying said selection signal simultaneously to one of a plurality of horizontal sensor-element lines of said sensor elements formed in said matrix arrangement, and
said detecting step includes simultaneously detecting the potential variation from the sensor elements of said one sensor-element line located in opposed relation to at least a portion of said circuit wiring.

14. The inspection method as defined in claim 13, wherein said circuit wiring includes a first circuit wiring and a second circuit wiring,
wherein said driving step includes inputting said selection signal in turn to said plurality of sensor-element lines so as to drive all of said sensor elements,
said detecting step includes detecting the potential variation from all of said sensor elements in synchronous with the input timing of said selection signal, and
said supplying step includes supplying said inspection signal to said first and second circuit wirings within the same frame (wherein one frame is a time period required for driving each of said sensor elements once) if no common sensor-element line is included between a first group of the sensor-element lines capable of detecting the potential variation in said first circuit wiring, and a second group of the sensor-element lines capable of detecting the potential variation in said second circuit wiring, and supplying said inspection signal to said first and second circuit wirings, respectively, in different frames if one or more common sensor-element lines are included between said first and second groups of the sensor-element lines.

15. The inspection method as defined in claim 14, wherein said plurality of sensor elements are formed in a matrix arrangement including a plurality of sensor-element lines,
wherein said driving step includes selectively driving only one or more of said sensor-element lines corresponding to the circuit wiring to be inspected, and
said detecting step includes simultaneously detecting the potential variation from the sensor elements of said one or more sensor-element lines located in opposed relation to at least a portion of said circuit wiring.

16. The inspection method as defined in claim 9 or 10, wherein said specific position of said circuit wiring is set around the input/output end of said circuit wiring.

17. A computer-readable recording medium storing thereon a computer program for achieving the inspection method as defined in claim 9 or 10, according to computer control.

18. A program sequence for achieving the inspection method as defined in claim 9 or 10, according to computer control.

19. An inspection apparatus for inspecting a circuit wiring on a circuit board, comprising:
supply means for supplying an inspection signal to said circuit wiring;
detecting means for detecting potential variation which is generated in said circuit wiring in response to said inspection signal, by use of a plurality of sensor elements; and
inspection control means for controlling said detecting means to detect the potential variation at a specific position of said circuit wiring.

20. An inspection apparatus for inspecting a circuit wiring on a circuit board, comprising:
supply means for supplying an inspection signal to said circuit wiring;
detecting means for detecting potential variation which is generated in said circuit wiring in response to said inspection signal, by use of a plurality of sensor elements;
image-data creating means for creating image data representing the shape of said circuit wiring in accordance with positional information from one or more of said plurality of sensor elements which have sensed said potential variation; and
inspection control means for controlling said detecting means to detect the potential variation at a specific position of said circuit wiring.

21. The inspection apparatus as defined in claim 19 or 20, wherein said circuit wiring is formed on said circuit board in a plural number, wherein said supply means is operable to supply said inspection signal to each of said circuit wirings at a different timing.

22. The inspection apparatus as defined in claim 19 or 20, which further includes selecting means for generating a selection signal to selectively drive only a part of said plurality of sensor elements.

23. The inspection apparatus as defined in claim 22, wherein said plurality of sensor elements are formed in a matrix arrangement,
wherein said selecting means is operable to input said selection signal simultaneously to one of a plurality of horizontal sensor-element lines of said sensor elements formed in said matrix arrangement, and
said detecting means is operable to simultaneously detect the potential variation from the sensor elements of said one sensor-element line located in opposed relation to at least a portion of said circuit wiring.

24. The inspection apparatus as defined in claim 23, wherein said circuit wiring includes a first circuit wiring and a second circuit wiring,
wherein said selecting means is operable to input said selection signal in turn to said plurality of sensor-element lines so as to drive all of said sensor elements,
said inspection control means is operable to control said detecting means to detect the potential variation from all of said sensor elements in synchronous with the input timing of said selection signal from said selecting means, and
said supply means is operable to supply said inspection signal to said first and second circuit wirings within the same frame (wherein one frame is a time period required for driving each of said plurality of sensor elements once) if no common sensor-element line is included between a first group of the sensor-element lines capable of detecting the potential variation in said first circuit wiring, and a second group of the sensor-element lines capable of detecting the potential variation in said second circuit wiring, and to supply said inspection signal to said first and second circuit wirings, respectively, in different frames, if one or more common sensor-element lines are included between said first and second groups of the sensor-element lines.

25. The inspection apparatus as defined in claim 22, wherein said plurality of sensor elements are formed in a matrix arrangement including a plurality of sensor-element lines,
wherein said selecting means is operable to selectively drive only one or more of said sensor-element lines corresponding to the circuit wiring to be inspected, and
said detecting means is operable to simultaneously detect the potential variation from the sensor elements of said one or more sensor-element lines located in opposed relation to at least a portion of said circuit wiring.

26. The inspection apparatus as defined in claim 19 or 20, wherein said specific position of said circuit wiring is set around the input/output ends of said circuit wiring.

27. An inspection method for inspecting a circuit wiring on a circuit board, comprising Steps of:
supplying an inspection signal to said circuit wiring; and
detecting potential variations which is generated in said circuit wiring in response to said supplied inspection signal, by use of a plurality of sensor elements,
wherein said detecting step includes detecting the voltage variation at a specific position of said circuit wiring while supplying said inspection signal to said circuit wiring.

28. An inspection method for inspecting a circuit wiring on a circuit board, comprising Steps of:
supplying an inspection signal to said circuit wiring;
detecting potential variation which is generated in said circuit wiring in response to said supplied inspection signal, by use of a plurality of sensor elements; and
creating image data representing the shape of said circuit wiring in accordance with positional information from one or more of said plurality of sensor elements which have sensed said potential variation,
wherein said detecting step includes detecting the potential variation at a specific position of said circuit wiring while supplying said inspection signal to said circuit wiring, and
said creating step includes creating said image data representing the shape of said region of said circuit wiring in accordance with said potential variation detected at said specific position.

29. The inspection method as defined in claim 27 or 28, wherein said circuit wiring is formed on said circuit board in a plural number, wherein said supplying step includes supplying said inspection signal to each of said circuit wirings at a different timing.

30. The inspection method as defined in claim 27 or 28, which further includes Step of selectively driving only a part of said plurality of sensor elements corresponding to said circuit wiring.

31. The inspection method as defined in claim 30, wherein said plurality of sensor elements are formed in a matrix arrangement,
wherein said driving step includes supplying said selection signal simultaneously to one of a plurality of horizontal sensor-element lines of said sensor elements formed in said matrix arrangement, and
said detecting step includes simultaneously detecting the potential variation from the sensor elements of said one sensor-element line located in opposed relation to at least a portion of said circuit wiring.

32. The inspection method as defined in claim 31, wherein said circuit wiring includes a first circuit wiring and a second circuit wiring,
wherein said driving step includes inputting said selection signal in turn to said plurality of sensor-element lines so as to drive all of said sensor elements,
said detecting step includes detecting the potential variation from all of said sensor elements in synchronous with the input timing of said selection signal, and
said supplying step includes supplying said inspection signal to said first and second circuit wirings within the same frame (wherein one frame is a time period required for driving each of said sensor elements once) if no common sensor-element line is included between a first group of the sensor-element lines capable of detecting the potential variation in said first circuit wiring, and a second group of the sensor-element lines capable of detecting the potential variation in said second circuit wiring, and supplying said inspection signal to said first and second circuit wirings, respectively, in different frames if one or more common sensor-element lines are included between said first and second groups of the sensor-element lines.

33. The inspection method as defined in claim 32, wherein said plurality of sensor elements are formed in a matrix arrangement including a plurality of sensor-element lines,
wherein said driving step includes selectively driving only one or more of said sensor-element lines corresponding to the circuit wiring to be inspected, and
said detecting step includes simultaneously detecting the potential variation from the sensor elements of said one or more sensor-element lines located in opposed relation to at least a portion of said circuit wiring.

34. The inspection method as defined in claim 27 or 28, wherein said specific position of said circuit wiring is set around the input/output end of said circuit wiring.

35. A computer-readable recording medium storing thereon a computer program for achieving the inspection method as defined in claim 27 or 28, according to computer control.

36. A program sequence for achieving the inspection method as defined in claim 27 or 28, according to computer control.
